(19) United States
(12) Patent Application Publication
(10) Pub. No.: US 2026/0145437 A1
(43) Pub. Date: May 28, 2026

(54) INK JET RECORDING METHOD AND INK JET RECORDING APPARATUS

(71) Applicant: CANON KABUSHIKI KAISHA, Tokyo (JP)

(72) Inventors: MAMIKO KAJI, Kanagawa (JP); HIROSHI ASAKAWA, Kanagawa (JP); AKIHIRO TAYA, Kanagawa (JP); HIDETAKA KAWAMURA, Kanagawa (JP); YUKO KATSUMOTO, Kanagawa (JP); KANAKO HIGUCHI, Kanagawa (JP)

(21) Appl. No.: 19/387,350

(22) Filed: Nov. 12, 2025

(30) Foreign Application Priority Data
Nov. 22, 2024 (JP) 2024-203725
Oct. 29, 2025 (JP) 2025-182973

(51) Int. Cl. B41J 2/21; B41M 5/00; B41M 7/00; C09D 11/322; C09D 11/54

(52) U.S. Cl. CPC B41J 2/2117; B41M 5/0017; B41M 7/0018; B41M 7/009; C09D 11/322; C09D 11/54

(57) ABSTRACT

An ink jet recording method of recording an image on a recording medium using an aqueous ink that contains a particle, a first resin particle and a second resin particle. The method includes heating the recording medium, to which the aqueous ink has been applied, to a temperature higher than or equal to a glass transition temperature Tg_{R1} or a melting point Tm_{R1} of the first rein particle and lower than a glass transition temperature Tg_{P} or a melting point Tm_{P} of the particle. The particle has an average primary particle diameter D_{P} of 150 nm or less. A density ratio of a density ρ_{R1} of the first resin particle to a density ρ_{R2} of the second resin particle is more than 1.0 times. The heating includes heating the recording medium to melt the first resin particle so that a hole is generated.

### BACKGROUND

### Field of the Technology

The present disclosure relates to an ink jet recording method and an ink jet recording apparatus.

### Description of the Related Art

In recent years, in the fields of commercial printing and the like, an ink jet recording method has been used to record an image of a white color on a recording medium of a color other than the white color, such as a transparent film, a translucent film or colored paper, using a white ink in some cases. An ink for recording an image of a white color contains a white pigment, such as titanium oxide, in some cases. The titanium oxide has a high specific gravity, and thus has a disadvantage of being easily precipitated. In order to deal with this disadvantage, an ink containing a hollow particle, in which the material has a low specific gravity and thus is unlikely to be precipitated, has been suggested (Japanese Patent Laid-Open No. 2010-194847). A hallow particle is used as a coloring material of a white color because the hole inside the particle scatters light. Further, an ink containing a coloring material and a plurality of kinds of resin particles with different compositions has been suggested (Japanese Patent Laid-Open No. 2024-102489).

An image recorded with a white ink is required to conceal the color of “ground” of a recording medium, that is, to have a high concealing property. As a result of examination conducted by the present inventors, it has been found that when water, such as rain, adheres to an image recorded with the ink described in Japanese Patent Laid-Open No. 2010-194847, water permeates into the hole of the hollow particle constituting the image so that scattering of light is reduced, and thus the concealing property (water wet concealing property) of the image are degraded. Particularly, in a case where the image is allowed to contain a large amount of the hollow particle in order to enhance the concealing property of the image, water is more likely to permeate into the image, and accordingly, the water wet concealing property tends to be degraded. A white ink is used for recording an image on a package, a poster or the like, but wetting of a recorded material with water needs to be considered in both cases, and thus degradation of the water wet concealing property is a disadvantage. Further, an image recorded with the ink described in Japanese Patent Laid-Open No. 2024-102489 also has a degraded concealing property.

### SUMMARY

Therefore, the present disclosure provides an ink jet recording method that enables recording of an image which has an excellent dry concealing property and suppresses degradation of the water wet concealing property when an aqueous ink having excellent precipitation resistance is used. Further, the present disclosure provides an ink jet recording apparatus used for the ink jet recording method.

That is, according to the present disclosure, there is provided an ink jet recording method of recording an image on a recording medium using an aqueous ink that contains a particle, a first resin particle and a second resin particle, the method including: applying the aqueous ink to the recording medium; and heating the recording medium, to which the aqueous ink has been applied, to a temperature higher than or equal to a glass transition temperature Tg_{R1} or a melting point Tm_{R1} of the first rein particle and lower than a glass transition temperature Tg_{P} or a melting point Tm_{P} of the particle, in which the particle has an average primary particle diameter D_{P} of 150 nm or less, a density ratio of a density ρ_{R1} of the first resin particle to a density ρ_{R2} of the second resin particle is more than 1.0 times, and in the heating of the recording medium, the recording medium is heated to melt the first resin particle so that a hole is generated.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for describing an example of a process of recording an image.

FIG. 2 is a schematic view for describing an example of the process of recording an image.

FIG. 3 is a schematic view for describing an example of the process of recording an image.

FIG. 4 is a side view schematically showing an embodiment of an ink jet recording apparatus according to the present disclosure.

FIG. 5 is a perspective view schematically showing an embodiment of the ink jet recording apparatus according to the present disclosure.

FIG. 6 is a side view schematically showing an embodiment of the ink jet recording apparatus according to the present disclosure.

### DESCRIPTION OF THE EMBODIMENTS

Hereinafter, the present disclosure will be described in more detail with reference to suitable embodiments. In the present disclosure, when a compound is a salt, the salt is present in an ink in a form of a dissociated ion, but the expression “containing a salt” is used for convenience. Further, an ink jet aqueous ink and an aqueous reaction liquid will also simply referred to as “ink” and “reaction liquid”. The physical property values are values at a normal temperature (25° C.) and a normal pressure (1 atm) unless otherwise specified. In the present disclosure, for convenience, the density of an aqueous ink is treated as 1 g/cm³ (1 g/mL).

The present inventors have examined an ink jet recording method that enables recording of an image which has an excellent concealing property in a state where the image is dried (dry concealing property) and is unlikely to degrade a concealing property in a case where water adheres to the image (water wet concealing property) when an aqueous ink having excellent precipitation resistance is used. As a result, it has been found that an image in which the dry concealing property can be improved and degradation of the water wet concealing property is suppressed can be recorded by satisfying the following requirements (i) to (v).
(i) The ink jet recording method includes an ink applying step of applying an ink containing a particle, a first resin particle and a second resin particle to a recording medium.
(ii) The ink jet recording method includes a heating step of heating the recording medium, to which the aqueous ink has been applied, to a temperature higher than or equal to a glass transition temperature Tg_{R1} (° C.) or a melting point Tm_{R1} (° C.) of the first rein particle and lower than a glass transition temperature Tg_{P} (° C.) or a melting point Tm_{P} (° C.) of the particle.
(iii) The particle has an average primary particle diameter D_{P} (nm) of 150 nm or less.
(iv) The density ratio of a density ρ_{R1} (g/cm³) of the first resin particle to a density ρ_{R2} (g/cm³) of the second resin particle is more than 1.0 times.
(v) In the heating step, the recording medium is heated to melt the first resin particle so that a hole is generated.

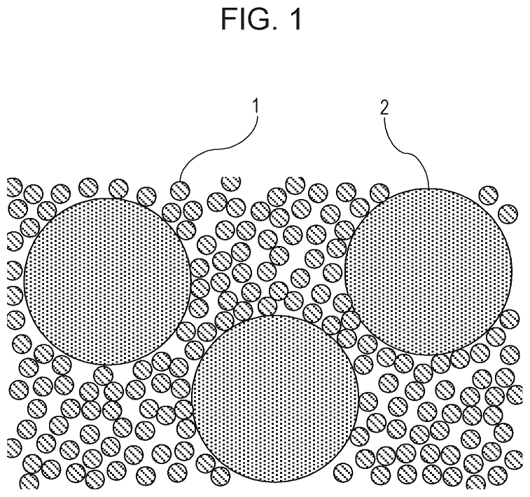

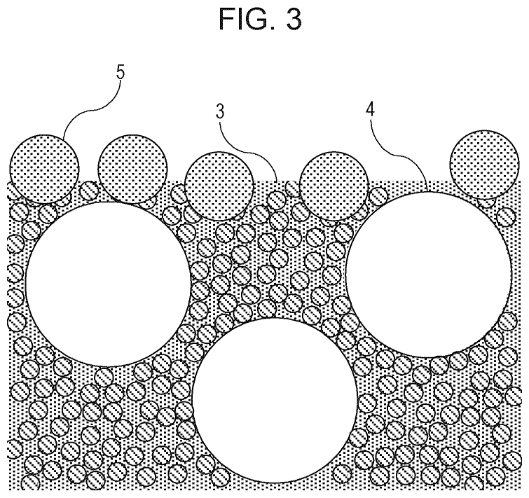

FIGS. 1 to 3 are schematic views for describing an example of the process of recording an image. When the ink is applied to a recording medium, the liquid component evaporates and thus the ink is dried to form an ink film in which a particle 1 and a first resin particle 2 in the ink are densely packed, as shown in FIG. 1. Thereafter, the image (recording medium) is heated to a temperature T_{H} (° C.) at which the first resin particle 2 is melted (temperature higher than or equal to the glass transition temperature Tg_{R1} (° C.) or the melting point Tm_{R1} (° C.) of the first rein particle). As a result, the resin generated by the melting of the first resin particle 2 permeates into gaps formed by a plurality of the particles 1 and a hole 4 is formed at a site where the first resin particle 2 is present (FIG. 3). In this case, since the heating temperature TH (° C.) is lower than the glass transition temperature Tg_{P} (° C.) or the melting point Tm_{P} (° C.) of the particle, the particle 1 is not melted. The resin generated by the melting of the first resin particle permeates into the gaps formed by the plurality of particles 1 to form a binder 3 which is a mixture of the particle 1 and the melted particle. Here, since the particle 1 has an average primary particle diameter D_{P} (nm) or 150 nm or less, visible light is hardly scattered by the particle 1. However, air having a low refractive index is present inside the hole 4. Accordingly, the refractive index of the hole 4 is relatively lower than the refractive index of the binder 3. Under the above-described circumstances, the incident light is scattered due to the difference in refractive index between the binder 3 and the hole 4. Therefore, an image with a high dry concealing property can be recorded even without using a component that is likely to be precipitated, such as titanium oxide having a large particle diameter.

As described above, the first resin particle is required to be melted by the heating step. For example, in a case where the drying step is performed only by evaporating the liquid component after the application of the ink to the recording medium and in a case where the heating step is performed at a temperature lower than the temperature at which the first resin particle is melted, the first resin particle is not melted. As a result, scattering due to the difference in refractive index between the binder 3 and the hole 4 does not occur, and thus an image with a high drying concealing property cannot be recorded. Further, when the heating step is performed at a temperature at which even the particle is melted, not only the first resin particle but also the particle are melted, and thus the hole is not formed. As a result, the above-described scattering does not occur, an image with a high dry concealing property cannot be recorded.

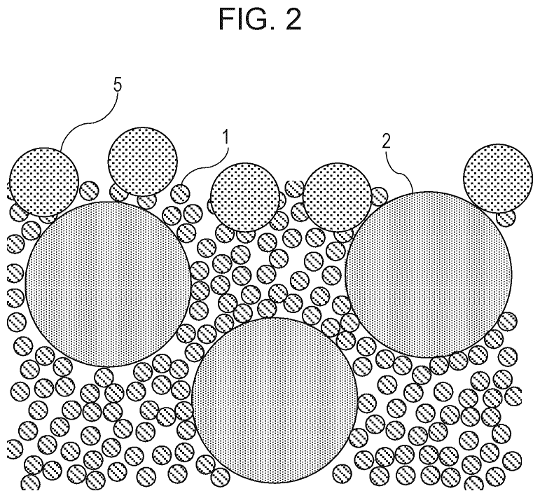

As shown in Stokes' law (Equation (A)), the precipitation is slowed down as the particle diameter decreases. Therefore, the precipitation is slowed down by using a particle having an average primary particle diameter D_{P} (nm) of 150 nm or less, which is a relatively small particle diameter, and thus an ink with excellent precipitation resistance can be obtained. When the particle has an average primary particle diameter D_{P} (nm) or more than 150 nm, since light is likely to be scattered, the dry concealing property is improved, but the precipitation speeds up. Therefore, the precipitation resistance cannot be obtained. Further, in a case where the size of the particle increases, the first resin particle is difficult to enter a state of being uniformly distributed around the particle as shown in FIGS. 1 and 2 when an image layer is formed, and accordingly, an image with a high dry concealing property cannot be recorded.

The density ratio of the density ρ_{R1} (g/cm³) of the first resin particle to the density ρ_{R2} (g/cm³) of the second resin particle is more than 1.0 times. The density (g/cm³) denotes the mass of a substance per unit volume of the substance, and the substance tends to float in a liquid, such as water, as the density of the substance decreases. In the process of evaporating the liquid component of the ink, the second resin particle having a density that is relatively smaller than the density of the first resin particle floats toward an air-liquid interface of the ink. At the same time, the amount of the liquid component of the ink decreases due to evaporation or the like, and thus the image layer has a structure in which a second resin particle 5 is unevenly distributed on the surface of the ink film where the particle 1 and the first resin particle 2 are densely packed, as shown in FIG. 2.

Typically, as the particle diameter of a particle decreases, the surface area of the particle per unit mass increases. When comparing with a particle having a large particle diameter, since the total surface area of a particle having a small particle diameter in contact with the liquid component, such as water, increases, the particle needs to have a larger amount of the hydrophilic group per unit mass required to disperse the particle in the liquid component. In a case of an image recorded with an ink that contains a particle having an average primary particle diameter D_{P} (nm) of 150 nm or less in a state where the particle is dispersed in the ink, a large amount of the hydrophilic group is present on the surface of the particle, and thus the hydrophilicity is high. In a case where the particle is an inorganic oxide among the forms of the particle, since the particle is formed of a hydrophilic oxide, the hydrophilicity is particularly high. Meanwhile, the first resin particle and the second resin particle are formed of “resin” having a relatively large molecular weight, and are in a state of being dispersed in the ink in a particle state without being dissolved in the ink, and accordingly, the hydrophobicity of the resin particles is high. Therefore, the particle having an average primary particle diameter D_{P} (nm) of 150 nm or less tends to have relatively high hydrophilicity, and the first resin particle and the second resin particle tend to have relatively low hydrophilicity.

In a case where the ink contains the particle and the first resin particle but does not contain the second resin particle, an image (ink film) in a state where the particle 1 having high hydrophilicity is exposed to the surface is formed as shown in FIG. 1. When water adheres to the image in this state, water is likely to permeate into the image, and thus the water wet concealing property is degraded. Meanwhile, in a case where an ink containing the particle, the first resin particle and the second resin particle is used, the second resin particle 5 is unevenly distributed on the surface side of the image (ink film) as shown in FIG. 2. In this manner, the amount of the particle present in a state of being exposed to the surface of the image is decreased, and the second resin particle having hydrophilicity lower than the hydrophilicity of the particle is unevenly distributed on the surface side of the image. Therefore, the hydrophilicity of the surface of the image is decreased, and thus water is unlikely to permeate into the image even when water adheres to the image. As a result, degradation of the water wet concealing property can be suppressed.

In a case where the density ρ_{R1} (g/cm³) of the first resin particle is the same as the density ρ_{R2} (g/cm³) of the second resin particle, the second resin particle cannot be unevenly distributed on the surface of the ink film efficiently. Therefore, an image in which the second resin particle is unevenly distributed on the surface of the ink film and the particle and the first resin particle are densely packed, as shown in FIG. 2, cannot be recorded, and accordingly, the dry concealing property cannot be sufficiently improved, and degradation of the water wet concealing property cannot be suppressed. Further, in a case where the density ρ_{R1} (g/cm³) of the first resin particle is less than the density ρ_{R2} (g/cm³) of the second resin particle, the first resin particle is unevenly distributed on the surface of the ink film. In this case, an ink film in which the particle and the first resin particle are densely packed cannot be formed, and the dry concealing property cannot be sufficiently improved, and degradation of the water wet concealing property cannot be suppressed.

### Ink Jet Recording Method and Ink Jet Recording Apparatus

The ink jet recording method of the present disclosure is a method of recording an image on a recording medium using an aqueous ink that contains a particle, a first resin particle and a second resin particle. The method includes an ink applying step of applying the aqueous ink to the recording medium. Further, the method also includes a heating step of heating the recording medium, to which the aqueous ink has been applied, to a temperature higher than or equal to the glass transition temperature Tg_{R1} (° C.) or the melting point Tm_{R1} (° C.) of the first rein particle and lower than the glass transition temperature Tg_{P} (° C.) or the melting point Tm_{P} (° C.) of the particle. The particle has an average primary particle diameter D_{P} (nm) of 150 nm or less, the density ratio of the density ρ_{R1} (g/cm³) of the first resin particle to the density ρ_{R2} (g/cm³) of the second resin particle is more than 1.0 times. In the heating step, the recording medium is heated to melt the first resin particle so that a hole is generated.

An ink jet recording apparatus of the present disclosure is an apparatus used for an ink jet recording method of recording an image by ejecting an aqueous ink from an ink jet type recording head and applying the aqueous ink to the recording medium. The ink jet recording apparatus of the present disclosure is an apparatus suitably used for the recording method described above. In the present disclosure, it is not necessary to irradiate the image with an active energy ray or the like to cure the image.

Hereinafter, the ink jet recording method and the ink jet recording apparatus (hereinafter, also simply referred to as “the recording method and the recording apparatus”) of the present disclosure will be described in detail.

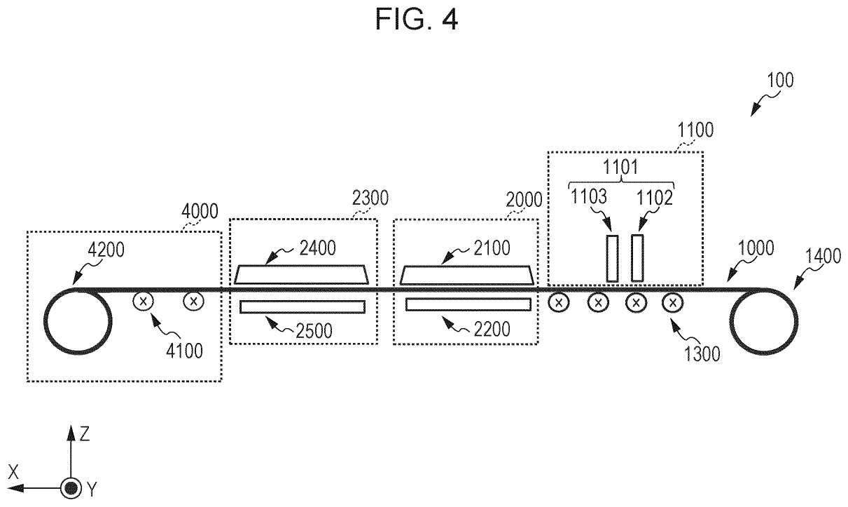

FIG. 4 is a side view schematically showing an embodiment of the ink jet recording apparatus according to the present disclosure. An ink jet recording apparatus 100 in the form shown in FIG. 4 is an ink jet recording apparatus that records an image on a recording medium wound in a roll shape using an ink and a reaction liquid containing a reactant that reacts with the ink. An X direction, a Y direction and a Z direction respectively denote a width direction (total length direction), a depth direction and a height direction of the ink jet recording apparatus. The recording medium is conveyed in the X direction.

The ink jet recording apparatus 100 according to the embodiment shown in FIG. 4 is configured to include a recording unit 1100, a drying unit 2000, a heating unit 2300 and a paper discharge unit 4000. In the recording unit 1100, various liquids including the ink are applied by a liquid applying device 1101 to a recording medium 1000 conveyed by a conveyance member 1300 from a feeding device 1400. In the drying unit 2000, the recording medium 1000 is conveyed along a first conveyance member 2200 while the tension is maintained, the liquid applied to the recording medium 1000 is dried by blowing air from the drying device 2100, and the liquid component, such as water, in the ink is evaporated to dry the recording medium 1000. In the heating unit 2300, the recording medium 1000 is conveyed along a second conveyance member 2500 while the tension is maintained, and the liquid applied to the recording medium 1000 is heated by a heating device 2400. In this manner, the liquid component, such as water, in the ink is further evaporated and the first resin particle is melted to generate a hole. Although not shown in FIG. 4, a cooling step of cooling the recording medium 1000 and a recording step of applying another ink may be performed after the drying step and the heating step.

The recording medium 1000 on which an image has been recorded is conveyed while being supported by a support member 4100 in the paper discharge unit 4000, and is wound up by a winding device 4200. The recording apparatus shown in FIG. 4 is configured to record an image on a roll-shaped recording medium, but the recording medium is not limited to a roll shape, and a sheet-shaped recording medium can also be used by changing the method of conveying the recording medium and a paper discharge device.

### Recording Unit

The recording unit is configured to include at least a recording unit 1100 that applies various liquids including ink. The liquid applying device 1101 is configured to include a reaction liquid applying device 1102 and an ink applying device 1103. The reaction liquid applying device 1102 shown in FIG. 4 is an example of a unit formed of an ink jet type ejection head. In addition, the reaction liquid applying device may be configured by using a gravure coater, an offset coater, a die coater, a blade coater or the like. The application of the reaction liquid using the reaction liquid applying device 1102 may be performed before or after the application of the ink as long as the reaction liquid can be brought into contact with the ink on the recording medium 1000. Here, the reaction liquid can be applied before the application of the ink in order to record a high-quality image on various recording media with different liquid absorption properties. An ink jet type ejection head (recording head) is used as the ink applying device 1103. Examples of an ejection method for the ejection head of the liquid applying device 1101 include a method of ejecting a liquid by causing film boiling in the liquid using an electrothermal converter to form air bubbles and a method of ejecting a liquid using an electromechanical converter.

The liquid applying device 1101 is a line head extending in the Y direction, and ejection orifices are arranged in a range where an image recording area of the available recording medium with the maximum width is covered. The ejection head on the lower side (recording medium 1000 side) has an ejection orifice surface having an ejection orifice formed therein, and the ejection orifice surface faces the recording medium 1000 with an extremely small distance of several millimeters. Hereinafter, the ink and the reaction liquid will also be collectively referred to as “liquid”.

The ink jet recording method can further include at least one step selected from the group consisting of a reaction liquid applying step of applying an aqueous reaction liquid containing a reactant that reacts with the ink to the recording medium and a drying step of drying a liquid component on the recording medium. Further, the ink jet recording method includes more suitably the reaction liquid applying step and particularly suitably a combination of the reaction liquid applying step and the drying step. In a case where the ink jet recording method includes a combination of these steps, the drying step can be performed after the reaction liquid applying step. That is, the reaction liquid applying step, the ink applying step, the drying step and the heating step can be performed in this order. When the reaction liquid is applied to the recording medium, the particle and the first resin particle in the ink can be rapidly aggregated to form an ink film in which the particle and the first resin particle are more densely packed. The reaction liquid will be described in detail below.

### Conveyance System

As shown in FIG. 4, the recording unit 1100 is configured to include the liquid applying device 1101 and the conveyance member 1300 that conveys the recording medium 1000. The reaction liquid and the ink are applied by the liquid applying device 1101 to a desired position of the recording medium 1000 to be conveyed by the conveyance member 1300. The reaction liquid applying device 1102 and the ink applying device 1103 receive an image signal of recording data and apply the reaction liquid and the ink respectively to the desired position.

In a case where the recording medium 1000 has a sheet shape, a conveyance member capable of fixing and conveying the recording medium 1000 can be used as the conveyance member 1300. Specific examples of a method of fixing and conveying the recording medium include a method of providing a hole in the conveyance member 1300 using a conveyance belt, a spur or a conveyance cylinder and suctioning the recording medium 1000 from the rear surface side thereof to fix the recording medium 1000 and a method of forming the conveyance member 1300 using an appropriate material and electrostatically adsorbing the recording medium 1000 to fix the recording medium 1000.

### Drying Unit

As shown in FIG. 2, the ink jet recording method may further include a drying step of evaporating the liquid component in the ink after the application of the ink prior to the heating step in order to form an ink film in which the second resin particle is unevenly distributed on the surface side of the image and the particle and the first resin particle are densely packed. When such a step is performed, the melted first resin particle can more efficiently permeate into the gaps formed by the plurality of particles, and thus an image having a hole as shown in FIG. 3 can be recorded.

As shown in FIG. 4, the drying unit 2000 is configured to include a drying device 2100 and a first conveyance member 2200. In the drying unit 2000, the recording medium 1000 where an image has been recorded after the application of the reaction liquid and the ink is dried by the drying device 2100 while being conveyed by the first conveyance member 2200 to evaporate the liquid component in the ink. The drying step is not required to evaporate the entire liquid component in the ink. That is, the liquid component on the recording medium is gradually evaporated even without the drying step, but the evaporation is promoted by performing the drying step, and the state shown in FIG. 2 can be efficiently achieved. The drying device 2100 may have any configuration as long as the evaporation of the liquid component on the recording medium 1000 can be promoted, and known devices such as an air blowing devices including fans, or heating devices such as heaters, can be used.

In a case where the recording medium is heated by the drying device 2100 in the drying unit 2000 in order to enhance the drying efficiency, the recording medium can be heated at a drying temperature T_{D} (CC) lower than or equal to the glass transition temperature or the melting point of the resin particle described below so that the first resin particle in the ink is not melted. That is, the drying temperature T_{D} (° C.) can be appropriately set according to the glass transition temperature Tg_{R1} or the melting point Tm_{R1} of the first resin particle. Specifically, the drying temperature T_{D} (° C.) in the drying unit 2000 can be lower than 70° C. or 65° C. or lower, and 30° C. or higher or 40° C. or higher. The heating temperature T_{D} (° C.) in the drying step denotes the maximum temperature of the recording medium (surface) reaching in the drying step. The heating temperature T_{D} (° C.) in the drying step can be measured by using, for example, a contact type thermometer in which a thermocouple or the like is brought into contact with the recording medium, a non-contact type infrared thermometer or the like.

### Heating Unit

As shown in FIG. 4, the heating unit 2300 is configured to include the heating device 2400 and the second conveyance member 2500. The heating unit 2300 heats the recording medium 1000 to which the reaction liquid and the ink have been applied while the recording medium 1000 is conveyed by the second conveyance member 2500. In this manner, the liquid component in the ink is evaporated, and a hole is generated by melting the resin particle.

The heating device 2400 may have any configuration as long as the recording medium 1000 can be heated, and various known devices of the related art, such as a hot air dryer and a heater, can be used. Among these, a non-contact type heater such as a heating wire or an infrared ray can be suitably used from the viewpoint of the safety or energy efficiency. Further, when heated air is sent to the recording medium 1000 by a fan that is built in the drying device 2400, the recording medium can be heated and dried at the same time. The recording medium 1000 may be heated from the surface (recording surface (front surface)) side thereof, to which the reaction liquid and the ink have been applied, from the rear surface side or from both surfaces thereof. The conveyance member 2500 may have a function of heating the recording medium.

The heating temperature T_{H} (° C.) in the heating step denotes the maximum temperature of the recording medium (surface) reaching in the heating step. The heating temperature T_{H} (° C.) can be measured by using, for example, a contact type thermometer in which a thermocouple or the like is brought into contact with the recording medium, a non-contact type infrared thermometer or the like. In examples described below, the temperature of the surface of the recording medium is measured at a position with a distance of 10 cm, which is oriented vertically to the surface of the recording medium using a non-contact thermometer (product name: “non-contact infrared thermometer digital radiation temperature sensor FT-H20”, manufactured by Keyence Corporation).

The heating temperature T_{H} (° C.) in the drying step can be set not to overheat the recording medium from the viewpoint of melting the first resin particle to form a hole in the ink film and suppressing deformation of the recording medium 1000. In consideration of the conveyance speed and the temperature of the environment where the recording medium is provided, the temperature of a drying unit can be set such that the recording medium has a desired temperature.

The heating temperature T_{H} (° C.) in the heating step is set according to the glass transition temperature Tg_{R1} or the melting point Tm_{R1} of the first resin particle. In a case where the first resin particle is a crystalline resin, the first resin particle has a glass transition temperature Tg_{R1} (° C.) and a melting point Tm_{R1} (° C.), and thus the recording medium can be heated at the melting point Tm_{R1} (° C.) or higher in order to melt the first resin particle. Specifically, the heating temperature T_{H} (° C.) in the drying unit 2000 can be 70° C. or higher, 80° C. or higher or 90° C. or higher. The heating temperature T_{H} (CC) can also be set to 200° C. or lower, 150° C. or lower or 130° C. or lower from the viewpoint of the upper temperature limit of the recording medium.

### Paper Discharge Unit

The recording medium 1000 after an image is recorded thereon is accommodated in the paper discharge unit 4000 (FIG. 4). After an image is recorded by the recording unit 1100, the recording medium 1000 having passed through the drying unit 2000 and the heating unit 2300 is conveyed by the conveyance member 4100. The recording medium 1000 is finally accommodated in a state where the recording medium 1000 is wound up in a roll shape by a paper discharge device 4200. Two or more paper discharge devices 4200 may be provided to respectively accommodate different recorded materials.

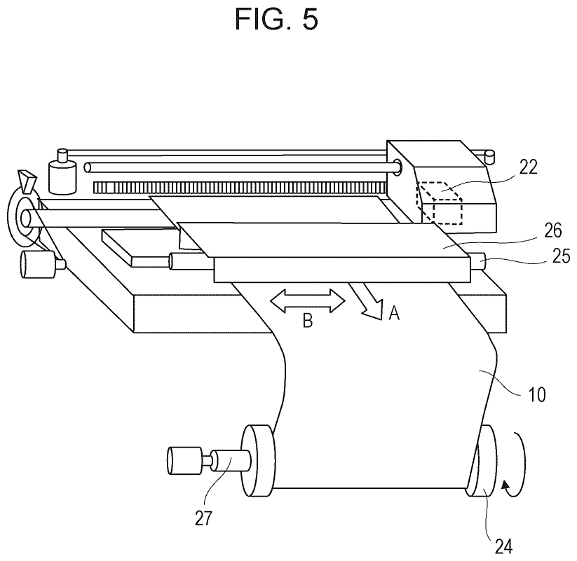

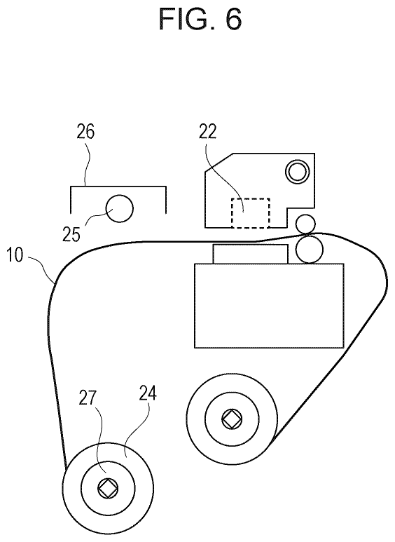

FIG. 5 is a perspective view schematically showing an embodiment of an ink jet recording apparatus different from the ink jet recording apparatus shown in FIG. 4. FIG. 6 is a side view showing the recording apparatus shown in FIG. 5. The recording apparatus according to the embodiment shown in FIGS. 5 and 6 includes an ink jet type recording head 22 that ejects an ink. The recording head may include a mechanism (temperature adjustment mechanism) that heats an ink ejected from the recording head. In a case where the recording head includes a temperature adjustment mechanism, the heating temperature of the ink ejected from the recording head can be 35° C. or higher to 70° C. or lower.

The ink jet recording apparatus shown in FIG. 5 can perform so-called multipass recording in which the ink is applied to a unit area of the recording medium by relative scanning performed a plurality of times on the recording head and the recording medium. The unit area can be set as any area such as one pixel or one band. In a case where an image is recorded with a combination of an ink of a color different from a white ink and the ink (white ink) containing the particle, the first resin particle and the second resin particle, the white ink and the ink of a different color can be applied by relative scanning performed differently each time.

A drying device (not shown) for performing the drying step is provided on an upstream side or a downstream side of a recording medium 10 in a conveyance direction intersecting with a main scanning direction in which the recording head 22 reciprocally scans. The drying step is not required to evaporate the entire liquid component in the ink. That is, the liquid component on the recording medium is gradually evaporated even without the drying step, but the evaporation is promoted by performing the drying step, and the state shown in FIG. 2 can be efficiently achieved. The drying device may have any configuration as long as the evaporation of the liquid component on the recording medium 10 can be promoted, and various known devices of the related art, such as an air blower and a heater, can be used. The heating temperature T_{D} (° C.) in the drying step may be set in the same manner as in the case of the ink jet recording apparatus shown in FIG. 4.

In the recording apparatus shown in FIGS. 5 and 6, a heater 25 supported by a frame (not shown) is disposed on a downstream side of the recording medium 10 in a sub-scanning direction A with respect to a position where the recording head 22 reciprocally scans in a sub-scanning direction B so that the recording medium 10 to which the ink has been applied is heated by the heater 25. Examples of the heater 25 include a sheathed heater and a halogen heater. The heater 25 is covered by a heater cover 26. The heater cover 26 is a member for efficiently irradiating the recording medium 10 with heat generated from the heater 25. The heater cover 26 is also a member that protects the heater 25. After the application of the ink, the liquid component in the ink is evaporated by the heater 25 to dry the image in the heating step. The heating temperature T_{H} (° C.) in the heating step may be set in the same manner as in the case of the ink jet recording apparatus shown in FIG. 4.

The recording medium 10 on which an image has been recorded is wound up by a winding spool 27 to form a roll-shaped winding medium 24. The recording medium shown in FIGS. 5 and 6 is configured to record an image on a roll-shaped recording medium, but the recording medium is not limited to a roll shape, and a sheet-shaped recording medium can also be used by changing the method of conveying the recording medium and the paper discharge device.

### Recording Medium

The type of the recording medium on which an image is recorded is not particularly limited, and any recording medium may be used. Since a white ink that can record an image of a white color or the like is suitably used, a recording medium of a color other than the white color, such as a transparent film, a translucent film or colored paper, can be used. The term “white color” has the same properties as those of “white color” of the ink described below. Further, a low to non-absorbing recording medium can be used as the recording medium. In the present specification, “low to non-absorbing recording medium” is a recording medium in which the water absorption amount from the start of contact to 30 msec^{1/2} is 10 mL/m² or less in the Bristow method. The Bristow method is a method that has been widely used as a method of measuring a liquid absorption amount in a short period of time, and is also employed in Japan Technical Association Of The Pulp And Paper Industry (JAPAN TAPPI). The details of the test method are described in Standard No. 51 “Paper and Paperboard, Liquid Absorbency Test Method, Bristow Method” of “Paper and Pulp Test Method of JAPAN TAPPI (2000 edition)”. A recording medium (glossy paper, mat paper or the like) provided with an ink receiving layer for ink jet recording or plain paper having no coating layer is “absorbing recording medium” having a water absorption amount of more than 10 mL/m².

Examples of the low-absorbing recording medium include a recording medium having no ink receiving layer and a recording medium having a thin ink receiving layer. Examples of such a recording medium include printing paper such as art paper, high-quality coated paper, medium-quality coated paper, high-quality lightweight coated paper, medium-quality lightweight coated paper, fine coated paper and cast coated paper. Further, examples of the non-absorbing recording medium include a recording medium having no ink receiving layer and a recording medium having a thin ink receiving layer. Examples of such a recording medium include a plastic film and a base material, such as paper, coated with plastic. Examples of the plastic include polyvinyl chloride, polyethylene terephthalate, polycarbonate, polystyrene, polyurethane, polyethylene and polypropylene. Other examples thereof include glass, a metal and a ceramic. Among these, a plastic film or a base material, such as paper, coated with plastic can be used. In the present specification, the term “recording medium” does not denote a transfer body, but denotes a target on which an image is recorded as a recorded material.

### Aqueous Ink

The ink used in the recording method is an ink jet aqueous ink containing the particle, the first resin particle, and the second resin particle. This ink can be a white ink. Here, the white ink includes an ink capable of recording a white image even when the ink does not exhibit a white color in an ink state. The white color denotes that the brightness (L*) and the chromaticity (a*, b*) in the CIEL*a*b* color specification system are respectively in ranges of 70≤L*≤100, −4.5≤a*≤2.0 and −6.0≤b*≤2.5. Hereinafter, the components and the like constituting the ink will be described in detail.

The term “resin particle” in the present specification denotes a resin present in a state of not being dissolved in an aqueous medium of an ink, and more specifically denotes a resin that can be present in an aqueous medium in the form of a particle having a particle diameter which can be measured by a dynamic light scattering method. In contrast, the term “water-soluble resin” denotes a resin present in a state of being dissolved in an aqueous medium of the ink. Whether or not a certain resin corresponds to “resin particle” can be determined by the following method. First, a liquid containing a resin as a determination target is prepared and diluted with pure water such that the content of the resin reaches about 1.0% to prepare a sample. Further, in a case where the particle diameter of the resin in the sample is measured by a dynamic light scattering method, the resin is determined to be “resin particle” (that is, “water-dispersible resin”) when a particle having a particle diameter is measured. Meanwhile, the resin is determined not to be “resin particle” (that is, “water-soluble resin”) when a particle having a particle diameter is not measured. Here, the measurement can be performed under conditions of, for example, a Set-Zero of 30 seconds, the number of times of measurement of 10 times, a measurement time of 120 seconds, a refractive index of 1.5 and a density of 1.0 in a true spherical shape. A particle size analyzer (for example, trade name “UPA-EX150”, manufactured by Nikkiso Co., Ltd.) or the like using a dynamic light scattering method can be used as a particle size distribution measuring device. Further, the particle size distribution measuring device to be used and the measurement conditions are not limited to those described above.

### Particle

The ink contains the particle. The particle may be a coloring material or a particle that does not exhibit a color, such as a resin particle. Among such particles, a colorless or white particle can be used in a case of recording a white image. In order to prevent the particle from being melted in the heating step of melting the first resin particle, the glass transition temperature Tg_{P} (° C.) or the melting point Tm_{P} (° C.) of the particle is required to be higher than the heating temperature T_{H} (° C.) in the heating step. Specifically, the glass transition temperature Tg_{P} (° C.) or the melting point Tm_{P} (° C.) of the particle can be 200° C. or higher to 3000° C. or lower. The glass transition temperature Tg_{P} (° C.) or the melting point Tm_{P} (° C.) of the particle can be measured with a differential scanning calorimeter (DSC).

### Average Primary Particle Diameter

The particle is usually dispersed in the ink in the form of a secondary particle obtained by aggregation of two or more primary particles. The particle is required to have an average primary particle diameter D_{P0} (nm) of 150 nm or less and can be set to 50 nm or less or 30 nm or less. The particle can have an average primary particle diameter D_{P0} (nm) of 5 nm or more. The average primary particle diameter of the particle can be measured by observing the particle using a scanning electron microscope. The average primary particle diameter D_{P0} (nm) of the particle can be calculated as an average value of the primary particle diameters of a plurality of the particles (for example, 100 particles).

### Content

The content V_{P} (% by volume) of the particle in the ink can be 5.0% by volume or less with respect to the total volume of the ink. The content V_{P} (% by volume) of the particle in the ink can be 1.5% by volume or more with respect to the total volume of the ink. When the content of the particle is less than 1.5% by volume, since the gaps formed by a plurality of the particles are substantially decreased, and the volume of the particle into which the resin generated by melting of the first resin particle permeates is also decreased, large holes are unlikely to be formed, and thus the dry concealing property cannot be sufficiently obtained in some cases. Further, the content C_{P} (% by mass) of the particle in the ink can be 5.0% by mass or more to 45.0% by mass or less, or 5.0% by mass or more to 40.0% by mass or less with respect to the total mass of the ink.

### Density

The density of the particle can be the same as or more than the densities of the first resin particle and the second resin particle. Here, the density of the particle is suitably more than the densities of the first resin particle and the second resin particle. Further, the density ρ (g/cm³) of the particle can be 1.00 g/cm³ or more to 5.00 g/cm³ or less, 2.00 g/cm³ or more to 5.00 g/cm³ or less, or 4.00 g/cm³ or more to 5.00 g/cm³ or less.

### Total Pore Volume

A particle having a total pore volume of 0.10 cm³/g or more, which is measured by a nitrogen adsorption and desorption method, can be used as the particle. The total pore volume of the particle is determined by an adsorption and desorption isotherm of nitrogen gas, which is measured by a nitrogen adsorption and desorption method. When the total pore volume of the particle is less than 0.10 cm³/g, since the gaps formed by a plurality of the particles are substantially decreased, and the volume of the particle into which the resin generated by melting of the first resin particle permeates is also decreased, large holes are unlikely to be formed, and thus the dry concealing property cannot be sufficiently obtained in some cases. The total pore volume of the particle can be 0.20 cm³/g or more in order to generate holes large enough to further enhance the dry concealing property. Further, the total pore volume of the particle can be 1.00 cm³/g or less, or 0.80 cm³/g or less.

### Volume-Based Cumulative 50% Particle Diameter

The particle is usually dispersed in the ink in a state of secondary particles obtained by aggregation of two or more primary particles. The volume-based cumulative 50% particle diameter D50_{P} (nm) of the particle can be 250 nm or less or 200 nm or less. An ink film in which the particle and the first resin particle are densely packed is likely to be formed by using a small particle having a volume-based cumulative 50% particle diameter D50_{P} (nm) of 200 nm or less. The volume-based cumulative 50% particle diameter D50_{P} (nm) of the particle can be 5 nm or more.

In the present specification, the expression “volume-based cumulative 50% particle diameter (D50)” denotes the diameter of the particle that is 50% of the total volume of the measured particle in the particle diameter cumulative curve when accumulated from a small particle diameter side, and can be measured with a particle size distribution measuring device using a dynamic light scattering method. The measurement can be performed under conditions of, for example, a Set-Zero of 30 seconds, the number of times of measurement of 3 times and a measurement time of 180 seconds in an aspherical shape. A particle size analyzer (for example, trade name “UPA-EX150”, manufactured by Nikkiso Co., Ltd.) or the like using a dynamic light scattering method can be used as a particle size distribution measuring device. Further, the particle size distribution measuring device to be used, the measurement conditions and the like are not limited to those described above.

### Refractive Index

The particle forms a part of the material constituting a binder, and thus a particle having a high refractive index can be used. Specifically, the refractive index of the particle can be 2.0 or more to 3.0 or less. Among such particles, titanium oxide having a relatively high refractive index can be used as the particle. The refractive index of titanium oxide can be 2.1 or more, or 2.5 or more to 2.8 or less.

### Suitable Materials

Specific suitable examples of the particle include at least one selected from the group consisting of titanium oxide, calcium carbonate, calcium phosphate, barium sulfate, zirconium oxide, silicon dioxide, kaolin, clay and the third resin particle. Among these, white pigments such as titanium oxide, calcium carbonate, calcium phosphate, barium sulfate, zirconium oxide, silicon dioxide, kaolin and clay are suitable, and titanium oxide is more suitable.

The titanium oxide is present in three crystal forms, which are a rutile type, an anatase type and a brookite type. Among these, rutile type titanium oxide with a low photocatalytic activity can be used. Examples of an industrial method of producing titanium oxide include a sulfuric acid method and a chlorine method, and titanium oxide produced by either production method can be used. The particle surface of the titanium oxide may be coated with alumina or zirconia. Further, the particle surface of the titanium oxide may be coated with an inorganic oxide such as silica, zinc oxide, or zirconia, or an organic substance such as a polyol. When titanium oxide having a particle surface coated with such a material is used, the photocatalytic activity is expected to be suppressed, and the dispersibility is expected to be improved.

The particle shape of calcium carbonate is cubic or spindle. Among the shapes, calcium carbonate having a uniform cubic shape can be used. Examples of calcium phosphate include monocalcium phosphate (Ca(H₂(PO₄)₂), dicalcium phosphate (CaHPO₄) and tricalcium phosphate (Ca₃(PO)₂). Among examples, apatite type calcium phosphate can be used, and hydroxyapatite (Ca₁₀(PO₆)OH)₂) can be suitably used.

The barium sulfate is roughly classified into barite powder and precipitated barium sulfate. The particle size of the precipitated barium sulfate can be controlled by adjusting the synthesis condition, and thus barium sulfate with an appropriate particle diameter can be obtained. Zirconium oxide, which is also referred to as zirconia, is known as a ceramic with high toughness. Pure zirconia is likely to be deteriorated due to a change in the crystalline structure accompanying a change in volume, caused by a change in temperature. Therefore, stabilized zirconia to which a stabilizing agent has been added to suppress the change in volume can be used.

Silicon dioxide can be synthesized by, for example, a Stober method. The Stober method is a method in which a hydrolysis and polycondensation reaction of alkoxysilane, which is a silica source, proceeds in a mixed aqueous solution of water, ethanol and ammonia. The particle diameter of the spherical particle to be obtained can be controlled by changing the concentration of each reactant.

Kaolin is a clay mineral containing a plurality of inorganic components. Specifically, kaolin is clay formed of a crystal structure of kaolinite, hydrated halloysite and halloysite. Further, the clay includes ilmenite, montmorillonite and vermiculite in addition to the component of kaolin. In a case where kaolin or clay is used to form a white ink, a particle with high whiteness can be selected.

The third resin particle is a resin particle different from the first resin particle and the second resin particle. The third resin particle is required to have a glass transition temperature Tg_{P} (° C.) or melting point Tm_{P} (° C.) higher than the heating temperature T_{H} (° C.) in the heating step so that the third resin particle is not melted in the heating step of melting the first resin particle. The third resin particle may satisfy the above-described condition, and the resin and the like forming the resin particle can be selected from those of the first resin particle and the second resin particle described below. Among such resin particles, a resin particle formed of a crosslinked resin can be used, and a resin particle formed of a crosslinked acrylic resin can be suitably used. The third resin particle is not required to contain a coloring material.

Examples of a method of dispersing the particle include a method of dispersing the particle by applying energy (mechanical or thermal) to a liquid medium containing the particle. Further, from the viewpoint of stably maintaining the dispersion state of the particle, a dispersant can be used. For example, a cationic component can be used as the dispersant for a particle, such as dry-process silica, which has a low isoelectric point and a negative electric charge of the particle surface in an aqueous medium. Further, an anionic component can be used as the dispersant for a particle, such as an alumina hydrate, which has a positive surface electric charge. The particle can also be dispersed by physically adsorbing the dispersant on the surface of the particle. The dispersant can effectively suppress aggregation of the particle by an electrical repulsive power generated between molecules or a steric hindrance of molecules, and thus is suitable. The dispersant can be appropriately selected according to the properties of the particle, such as an acid, an alkali or a resin. The content (% by mass) of the dispersant in the ink can be 0.5% by mass or more to 15.0% by mass or less, or 1.0% by mass or more to 10.0% by mass or less with respect to the content (% by mass) of the particle. When the content of the dispersant is less than 0.5% by mass, the dispersion state of the particle is likely to be destabilized, and the particle is likely to be aggregated. Further, when the content of the dispersant is more than 15.0% by mass, the amount of the dispersant is excessive, which may lead to destabilization of the dispersion state of the particle, and as a result, the particle is likely to be aggregated.

### First Resin Particle

The ink contains the first resin particle. The first resin particle is melted by being heated at the glass transition temperature Tg_{R1} (° C.) or melting point Tm_{R1} (° C.) or higher in the heating step, and a hole is generated. The resin particle is not required to be a hollow particle having a hole therein.

The first resin particle can maintain the shape of the particle without being melted before the heating step is performed. When the first resin particle is melted before the heating step is performed, the mixing of the particle and the first resin particle does not proceed rapidly, or the first resin particle is likely to be melted, a desired hole is difficult to form, the light scattering efficiency is decreased, and thus the dry concealing property cannot be sufficiently obtained in some cases. The first resin particle can have a property of not being substantially melted at a normal temperature (25° C.) so that the first resin particle maintains the shape of the particle and is in a state of not being melted before the heating step is performed. Specifically, (i) the first resin particle can have a glass transition temperature Tg_{R1} (° C.) of 25° C. or higher or (ii) the resin forming the first resin particle can be a crystalline resin and the first resin particle can have a melting point Tm_{R1} (° C.) of 25° C. or higher. The expression “the melting point Tm_{R1} (° C.) of the first resin particle is 25° C. or higher” is used when the condition (ii) is satisfied.

Both the glass transition temperature Tg_{R1} (° C.) and the melting point Tm_{R1} (° C.) of the first resin particle can be 100° C. or lower, or 80° C. or lower. The glass transition temperature Tg_{R1} (° C.) and the melting point Tm_{R1} (° C.) of the first resin particle can be measured with a differential scanning calorimeter (DSC).

Whether the resin forming the first resin particle is an amorphous resin or a crystalline resin can be determined by measuring the degree of crystallinity using a differential scanning calorimeter. A resin in which no melting peak is observed with a differential scanning calorimeter is determined to be an amorphous resin. Further, a resin in which a melting peak is observed is determined to be a crystalline resin. In a case where the resin is determined to be a crystalline resin, heat of fusion is determined from the peak area, and the degree of crystalline can also be determined from the ratio between the determined heat of fusion and heat of fusion of a perfect crystal substance in which the degree of crystallinity determined from theoretical calculation is 100%.

Whether or not the first resin particle is melted in the heating step can be easily determined by cutting the recording medium on which an image has been recorded before and after the heating step and observing the image with a scanning electron microscope or the like. Further, it can be determined that the first resin particle is melted and a hole is generated when the particle diameter of the first resin particle in the image before the heating step is measured and a difference between the size of the hole in the image and the particle diameter of the first resin particle after the heating step is small (for example, within 10%). It can be simply determined that the first resin particle is melted and a hole is generated when the spherical first resin particle disappears from the image after the heating step and a hole having almost the same size as the size of the first resin particle or a hole connecting particles is observed.

Specific examples of a method for confirming that the first resin particle is melted due to heating of the recording medium and the hole is generated in the heating step include the following method. First, the recording medium on which an image has been recorded is cut, and the image of the cut surface observed with a scanning electron microscope is captured. Thereafter, the captured image is binarized, and the area ratio of the black portion, which corresponds to the hole, to the entire image is calculated. When the area ratio of the hole to the image to be obtained by this method is 5% or more, it can be determined that the first resin particle is melted due to heating of the recording medium and the hole is generated. From the viewpoint of scattering efficiency, the area ratio thereof can be 10% or more, or 20% or more, and 60% or less. When the area ratio of the hole is less than 20%, since the number of holes in the ink film is small, the scattering efficiency is not increased, and the dry concealing property cannot be sufficiently obtained in some cases. Further, when the area ratio of the hole is less than 20%, since the number of holes in the ink film is small, the hole is filled with water even in a case where a small amount of water adheres to the image, and thus the water wet concealing property cannot be sufficiently obtained in some cases. Meanwhile, when the area ratio of the hole is 60% or more, since water is extremely easily transmitted in a case where water adheres to the image, the water wet concealing property cannot be sufficiently obtained in some cases.

### Content

The content C_{R1} (% by mass) of the first resin particle in the ink can be 2.5% by mass or more to 17.0% by mass or less, or 2.5% by mass or more to 14.0% by mass or less with respect to the total mass of the ink. Further, the content V_{R1} (% by volume) of the first resin particle in the ink can be 2.5% by volume or more to 17.0% by volume or less, or 2.5% by volume or more to 14.0% by volume or less with respect to the total volume of the ink.

The volume ratio of the content V_{R1} (% by volume) of the first resin particle to the content V_{P} (% by volume) of the particle in the ink can be 1.3 times or more to 5.0 times or less, or 1.8 times or more to 4.0 times or less. When the volume ratio thereof is more than 5.0 times, since the amount of the first resin particle is relatively large, the amount of the fused first resin particle increases, and thus the hole with a desired size is difficult to form. As a result, the dry concealing property of the image cannot be sufficiently obtained in some cases. In addition, the refractive index of the binder formed of the melted first resin particle and the particle is likely to be small, the light scattering efficiency is decreased, and therefore, the dry concealing property cannot be sufficiently obtained in some cases. Meanwhile, when above-described the volume ratio is less than 1.3 times, the number of holes to be formed is decreased, and thus the dry concealing property cannot be sufficiently obtained in some cases.

### Density

The density ρ_{R1} (g/cm³) of the first resin particle can be 1.00 g/cm³ or more to 2.00 g/cm³ or less, or 1.00 g/cm³ or more to 1.50 g/cm³ or less. Further, the density ratio of the density ρ_{P} (g/cm³) of the particle to the density ρ_{R1} (g/cm³) of the first resin particle can be 2.1 times or more. When the density ratio is less than 2.1 times, the precipitation speed of the particle is decreased, an ink film in which the particle and the first resin particle are densely packed is unlikely to be formed, and thus the dry concealing property and the water wet concealing property cannot be sufficiently obtained in some cases. The density ratio thereof can be 4.5 times or less.

### Volume-Based Cumulative 50% Particle Diameter

The hole to be formed in the heating step is generated when the first resin particle is melted, and the melted resin permeates into the gaps formed by a plurality of particles. Therefore, the size of the hole to be formed greatly affects the particle diameter of the first resin particle. Meanwhile, the light scattering efficiency also greatly affects the size of the hole to be formed. Therefore, from the viewpoint of further increasing the light scattering efficiency, the volume-based cumulative 50% particle diameter D50_{R1} (nm) of the first resin particle can be 80 nm or more to 400 nm or less, or 150 nm or more to 250 nm or less.

### Refractive Index

From the viewpoint of forming a binder having a high refractive index, the first resin particle having a relatively high refractive index can be used. The refractive index of the first resin particle can be 1.5 or more, or 1.6 or more, and 2.5 or less.

### Acid Value and Weight-Average Molecular Weight

The acid value of the resin constituting the first resin particle can be 5 mgKOH/g or more to 100 mgKOH/g or less. The weight-average molecular weight of the resin constituting the first resin particle can be 1000 or more to 3000000 or less, or 100000 or more to 3000000 or less. The first resin particle is not required to contain a coloring material.

### Suitable Materials

Examples of the resin forming the first resin particle include an acrylic resin, a polyester-based resin, a urethane-based resin, a vinyl chloride-based resin, and a styrene-based resin. Among these, from the viewpoint of ink jet properties, an acrylic resin, a polyester-based resin and a urethane-based resin can be used. When the first resin particle formed of a resin other than the resins described above is used, ejection is likely to be destabilized, and as a result, the dry concealing property of the image cannot be sufficiently obtained in some cases. Among the examples, an acrylic resin can be used, and an acrylic resin having a unit derived from styrene can be suitably used. The details of the resin constituting the first resin particle will be described below. The acrylic resin may be a homopolymer formed of only one kind of monomer unit or a copolymer formed of a plurality of kinds of monomer units. The resin forming the first resin particle can be appropriately selected from the same resin compositions as described in the section of “other resins” below.

### Second Resin Particle

The ink contains the second resin particle. Further, the density ratio of the density ρ_{R1} (g/cm³) of the first resin particle to the density ρ_{R2} (g/cm³) of the second resin particle is required to be more than 1.0 times. That is, the density ρ_{R2} (g/cm³) of the second resin particle is required to be less than the density ρ_{R1} (g/cm³) of the first resin particle. The density ratio of the density ρ_{R1} (g/cm³) of the first resin particle to the density ρ_{R2} (g/cm³) of the second resin particle can be 1.5 times or less. Further, the main component constituting an aqueous ink is typically water, and accordingly, the density ρ_{R2} (g/cm³) of the second resin particle can be less than 1.00 g/cm³, which is the density of water. The density ρ_{R2} (g/cm³) of the second resin particle can be 0.50 g/cm³ or more, or 0.90 g/cm³ or more.

### Content

The content C_{R2} (% by mass) of the second resin particle in the ink can be 0.2% by mass or more to less than 5.0% by mass, or 0.4% by mass or more to less than 4.0% by mass with respect to the total mass of the ink. Further, the content V_{R2} (% by volume) of the second resin particle in the ink can be 0.1% by volume or more to 10.0% by volume or less, or 1.0% by volume or more to 5.0% by volume or less with respect to the total volume of the ink. The volume ratio of the content V_{R2} (% by volume) of the second resin particle to the content V_{R1} (% by volume) of the first resin particle in the ink can be 0.06 times or more to 0.6 times or less. When the volume ratio thereof is less than 0.06 times, the amount of the second resin particle is relatively small, the effect of reducing the hydrophilicity of the image surface is degraded, and thus the water wet concealing property cannot be sufficiently obtained in some cases. When the volume ratio thereof is more than 0.6 times, the amount of the second resin particle is relatively large, the melting of the first resin particle due to heating and the effect of generation of the hole are decreased, and thus the dry concealing property cannot be sufficiently obtained in some cases. The volume ratio thereof can be 0.2 times or more to 0.4 times or less.

### Glass Transition Temperature and Melting Point

The glass transition temperature Tg_{R2} (° C.) or the melting point Tm_{R2} (° C.) of the second resin particle can be higher than the heating temperature T_{H} (° C.) in the heating step. When the glass transition temperature Tg_{R2} (° C.) or the melting point Tm_{R2} (° C.) of the second resin particle is lower than the heating temperature T_{H} (° C.) in the heating step, the resin in which at least some of the second resin particle is melted in the heating step. The melted resin then permeates the gaps formed by a plurality of particles and the holes where the first resin particle is present. As a result, the amount of the second resin particle exposed to the surface of the image is decreased, and thus the water wet concealing property cannot be sufficiently obtained in some cases. The glass transition temperature Tg_{R2} (° C.) or the melting point Tm_{R2} (° C.) of the second resin particle can be 40° C. or higher to 120° C. or lower, or 50° C. or higher to 100° C. or lower. The glass transition temperature Tg_{R2} (° C.) or the melting point Tm_{R2} (° C.) of the second resin particle can be measured by a differential scanning calorimeter (DSC).

### Volume-Based Cumulative 50% Particle Diameter

The volume-based cumulative 50% particle diameter D50_{R2} (nm) of the second resin particle can be 100 nm or more to 200 nm or less. When the volume-based cumulative 50% particle diameter D50_{R2} (nm) of the second resin particle is 100 nm or more, the second resin particle can be efficiently unevenly distributed on the surface of the image, and thus the abrasion resistance of the image can be improved. Further, when volume-based cumulative 50% particle diameter D50_{R2} (nm) of the second resin particle is 200 nm or less, surface scattering of the image can be effectively suppressed, and thus the dry concealing property of the image can be further improved.

### Suitable Materials

Examples of the resin forming the second resin particle include a wax, an alkyl ketene dimer, an alkenyl succinic anhydride and rosin. The second resin particle formed of these resins has a desired density and is likely to decrease the hydrophilicity of the image surface, and thus is suitable. Among the examples, since the dispersion state in the ink is likely to be stably maintained, a wax, an alkyl ketene dimer, or rosin can be used, and a wax can be suitably used as the resin forming the second resin particle. When the wax is compared with the alkyl ketene dimer or the alkenyl succinic anhydride, since the wax has high hydrophobicity and a low density, the water wet concealing property can be further improved.

The wax may be a composition, into which components other than the wax are blended, or just a wax. The wax particle may be dispersed by a dispersant such as a surfactant or a resin. The wax in a narrow sense is an ester of a water-insoluble higher monohydric or dihydric alcohol and a fatty acid and includes an animal-based wax and a vegetable-based wax, but excludes oils and fats. The wax in a broad sense include fats having a high melting point, a mineral-based wax, a petroleum-based wax and a blended substance or a modified substance of various waxes. In the present disclosure, the wax in a broad sense can be used without particular limitation. The wax in a broad sense can be classified into a natural wax, a synthetic wax, a blended substance (blended wax) thereof and a modified substance (modified wax) thereof.

Examples of the natural wax include an animal-based wax, a vegetable-based wax, a mineral-based wax and a petroleum-based wax. Examples of the animal-based wax include beeswax, spermaceti and wool wax (lanolin). Examples of the vegetable-based wax include palm wax, carnauba wax, candelilla wax, rice wax, Japan wax and sugarcane wax. Examples of the mineral-based wax include montan wax, ozokerite, ceresin and lignite wax. Examples of the petroleum-based wax such as paraffin wax, microcrystalline wax and petrolatum.

Examples of the synthetic wax include a hydrocarbon-based wax such as Fischer-Tropsch wax or polyolefin wax (such as polyethylene wax or polypropylene wax). The blended wax is a mixture of various waxes. The modified wax is a wax obtained by performing a modification treatment such as oxidation, hydrogenation, alcohol modification, acrylic modification or urethane modification on the various waxes.

The rosin is a natural resin containing rosin acid as a main component. Examples of the rosin include raw material rosin such as gum rosin, wood rosin or tall oil rosin, a polymer of raw material rosin and a modified product of raw material rosin (such as a disproportionated product, a hydrogenated product, an esterified product, a phenol-modified product or an unsaturated acid-modified product). Among these, rosin ester can be used. The rosin particle may be dispersed by a dispersant.

The alkenyl succinic anhydride is a compound having an alkenyl group and a succinic anhydride structure, which is obtained by a thermal addition reaction of an olefin and maleic anhydride. The alkyl ketene dimer is a material which has been widely used as a sizing agent (water-resistant agent) for paper produced mainly from wood pulp, and is produced using a higher fatty acid as a raw material. The higher fatty acid can have 8 to 24 carbon atoms or 16 to 18 carbon atoms. The alkyl ketene dimer particle may be dispersed by a dispersant.

The resin constituting the second resin particle can be Fischer-Tropsch wax or polyolefin wax. Since Fischer-Tropsch wax and polyolefin wax are synthetic waxes, the amount of impurities is small, the second resin particle is efficiently unevenly distributed on the surface side of the image, and thus the water wet concealing property can be further improved. From the viewpoint that particularly the water wet concealing property is likely to be improved, Fischer-Tropsch wax can be used as the resin constituting the second resin particle.

### Dispersion Method

Examples of a method of dispersing the second resin particle include a method of dispersing the second resin particle using a dispersant (resin dispersion type) and a method of dispersing the second resin particle without using a dispersant (self-dispersion type). Among the examples, the resin dispersion type can be used. As described above, a resin exhibiting hydrophobicity can be suitably used as the resin forming the second resin particle in order to improve the water wet concealing property by decreasing the hydrophilicity of the image surface. Further, a dispersant can be used for stably dispersing the resin particle formed of a hydrophobic resin in an aqueous medium.

The dispersant is not limited as long as the resin can be emulsified or dispersed. Specific examples thereof include an anionic compound containing an ionic hydrophilic group such as a carboxylic acid group, a sulfonic acid group, or a sulfuric acid ester group, and a nonionic compound containing a nonionic hydrophilic group such as a hydroxy group or an ethylene oxide group. Examples of the anionic compound include a linear higher carboxylic acid (salt), low-molecular-weight compounds such as sulfonic acid (salt), an alkylbenzene sulfonate, an alkyl sulfate, a polyoxyethylene alkyl sulfate and an alkyl phosphate, and resins such as an ethylene acrylic acid copolymer. Further, examples of the nonionic compound polyoxyethylene alkyl ether, polyoxypropylene alkyl ether and polyoxyethylene-polyoxypropylene alkyl ether.

The nonionic compound can be used as the dispersant of the resin forming the second resin particle. In the process in which the ink is applied to the recording medium, and the dispersion state of the second resin particle is destabilized due to the evaporation of the liquid component in the ink, the concentration of the component (salt) that can be ionically dissociated also increases along with an increase in concentration of the solid content due to the evaporation of the liquid component. Here, when the second resin particle dispersed by an anionic compound is used, the second resin particle is rapidly aggregated due to salting-out along with the increase in concentration of the salt. On the contrary, since the second resin particle dispersed by the nonionic compound is hardly affected by salting-out even when the concentration of the solid content and the salt increases, the dispersion state of the second resin particle is maintained for a longer period of time, and thus rapid aggregation is suppressed. As a result, the state where the second resin particle 5 is unevenly distributed on the surface side of the ink film in which the particle 1 and the first resin particle 2 are densely packed can be more efficiently formed, and accordingly, the dry concealing property can be further improved. In addition, in a case where the ink and the reaction liquid are used in combination, rapid aggregation of the second resin particle when the reaction liquid and the ink are brought into contact with each other can be suppressed by using the second resin particle dispersed by the nonionic compound, and therefore, the water wet concealing property can be further improved.

### Other Resins

The ink may further contain resins (other resins) other than the resin particles described above. The content (% by mass) of the resins (other resins) in the ink can be 0.1% by mass or more to 20.0% by mass or less, or 0.5% by mass or more to 15.0% by mass or less with respect to the total mass of the ink.

The other resins can be added to the ink to stabilize the dispersion state of the pigment, that is, to serve as a resin dispersant or an assistant thereof. Further, the resin can be added to the ink to improve various properties of an image to be recorded. Examples of the form of the resin include a block copolymer, a random copolymer, a graft copolymer and a combination thereof. Further, the other resins may be water-soluble resins or resin particles. Among these, water-soluble resins can be used.

### Composition of Resin

Examples of the resin include an acrylic resin, a urethane-based resin, a polyester-based resin and an olefin-based resin. Among these, an acrylic resin or a urethane-based resin can be used, and an acrylic resin formed of a unit derived from (meth)acrylic acid or (meth)acrylate can be suitably used.

An acrylic resin having a hydrophilic unit and a hydrophobic unit as constituent units can be used as the acrylic resin. Among such examples, a resin having a hydrophilic unit derived from (meth)acrylic acid and a hydrophobic unit derived from at least one selected from the group consisting of a monomer having an aromatic ring and a (meth)acrylic acid ester-based monomer is suitable. Particularly, a resin having a hydrophilic unit derived from (meth)acrylic acid and a hydrophobic unit derived from at least one selected from the group consisting of styrene and α-methylstyrene is suitable. These resins are likely to interact with a pigment and thus can be suitably used as a resin dispersant for dispersing the pigment.

The hydrophilic unit is a unit containing a hydrophilic group such as an anionic group. The hydrophilic group can be formed by, for example, polymerizing a hydrophilic monomer containing a hydrophilic group. Specific examples of the hydrophilic monomer containing a hydrophilic group include an acidic monomer containing a carboxylic acid group such as (meth)acrylic acid, itaconic acid, maleic acid or fumaric acid, and an anionic monomer such as an anhydride or a salt of the acidic monomer. Examples of a cation constituting a salt of the acidic monomer include an ion such as lithium, sodium, sodium, potassium, ammonium or organic ammonium. The hydrophobic unit is a unit containing no hydrophilic group such as an anionic group. The hydrophobic unit can be formed by, for example, polymerizing a hydrophobic monomer containing no hydrophilic group such as an anionic group. Specific examples of the hydrophobic monomer include a monomer having an aromatic ring such as styrene, α-methylstyrene or benzyl (meth)acrylate and a (meth)acrylic acid ester-based monomer such as methyl (meth)acrylate, butyl (meth)acrylate and 2-ethylhexyl (meth)acrylate.

The urethane-based resin can be obtained by, for example, reacting a polyisocyanate with a polyol. Further, the urethane-based resin may be obtained by further reacting a chain extender. Examples of the olefin-based resin include polyethylene and polypropylene.

The polyester-based resin is typically formed of a unit derived from a polyhydric alcohol and a unit derived from a polycarboxylic acid. Examples of the polyhydric alcohol that forms a unit derived from a polyhydric alcohol, which constitutes a polyester-based resin through a reaction, include a dihydric to tetrahydric polyhydric alcohol. Examples of the polyhydric alcohol include polyhydric alcohols containing an aliphatic group, polyhydric alcohols containing an aromatic group and sugar alcohols.

Examples of the polyhydric alcohol include dihydric alcohols such as ethylene glycol (1,2-ethanediol), neopentyl glycol (2,2-dimethyl-1,3-propanediol), 1,3-propanediol, 1,4-butanediol, benzenediol and 2,2-bis(4-hydroxyphenyl)propane (bisphenol A), trihydric alcohols such as glycerin, trimethylolethane and trimethylolpropane and tetrahydric alcohols such as pentaerythritol. Further, an oligomer (low-molecular-weight polymer having a molecular weight of 1000 or less) can also be used as the polyhydric alcohol. From the viewpoint of easily adjusting the weight-average molecular weight of the polyester resin, dihydric or trihydric polyhydric alcohols can be used.

Examples of the polycarboxylic acid that forms a unit derived from a polycarboxylic acid, which constitutes a polyester-based resin through a reaction, include divalent to tetravalent polycarboxylic acids. Examples of the structure of the polycarboxylic acid include polycarboxylic acids containing an aliphatic group, polycarboxylic acids containing an aromatic group and nitrogen-containing polycarboxylic acids. Examples of the polycarboxylic acid include divalent carboxylic acids such as glutaric acid, adipic acid, terephthalic acid, isophthalic acid and 2,6-naphthalenedicarboxylic acid, trivalent carboxylic acids such as trimellitic acid, and tetravalent carboxylic acids such as ethylenediaminetetraacetic acid. Further, an oligomer (low-molecular-weight polymer having a molecular weight of 1000 or less) can also be used as the polycarboxylic acid. From the viewpoint of easily adjusting the weight-average molecular weight and the acid value of the polyester resin, divalent or trivalent polycarboxylic acids can be used.

### Physical Properties of Other Resins

The acid value of the water-soluble resin can be 100 mgKOH/g or more to 250 mgKOH/g or less. The weight-average molecular weight of the water-soluble resin can be 3000 or more to 15000 or less. Further, the acid value of the resin constituting the resin particle can be 5 mgKOH/g or more to 100 mgKOH/g or less. The weight-average molecular weight of the resin constituting the resin particle can be 100000 or more to 3000000 or less. The resin particle is not required to contain a coloring material.

### Aqueous Medium

The ink is an aqueous ink containing at least water as an aqueous medium. The ink can contain water or an aqueous medium which is a mixed solvent of water and a water-soluble organic solvent. Deionized water or ion exchange water can be used as water. The content (% by mass) of water in the aqueous ink can be 50.0% by mass or more to 95.0% by mass or less with respect to the total mass of the ink. Further, the content (% by mass) of the water-soluble organic solvent in the aqueous ink can be 3.0% by mass or more to 50.0% by mass or less with respect to the total mass of the ink. Any water-soluble organic solvent that can be used for an ink jet ink, such as alcohols, (poly)alkylene glycols, glycol ethers, nitrogen-containing solvents or sulfur-containing solvents can be used as the water-soluble organic solvent.

The water-soluble organic solvent can have a boiling point of 250° C. or lower, or 230° C. or lower. The water-soluble organic solvent having a boiling point of 250° C. or lower is likely to be rapidly evaporated by the heating step, but since the water-soluble organic solvent having a boiling point of higher than 250° C. is likely to remain in the hole of the image, and the refractive index of the hole is likely to be decreased, the dry concealing property cannot be sufficiently obtained in some cases.

### Other Components

The ink may further contain a water-soluble organic compound in a solid state at 25° C., such as urea or a derivative thereof, trimethylolpropane or trimethylolethane. The content (% by mass) of the water-soluble organic compound in a solid state at 25° C. in the ink can be 0.1% by mass or more to 10.0% by mass or less with respect to the total mass of the ink. Further, the ink may contain various other components in addition the above-described components as necessary. Examples of the other components include various additives such as a surfactant, a defoaming agent, a pH adjuster, a viscosity adjuster, a rust inhibitor, a preservative, a fungicide, an antioxidant and a reducing inhibitor. Here, the ink suitably contains no reactant used for the above-described reaction liquid.

### Physical Properties of Ink

The ink is an aqueous ink to be applied to the ink jet method. Therefore, the physical properties thereof can be appropriately controlled from the viewpoint of the reliability. Specifically, the surface tension of the ink at 25° C. can be 20 mN/m or more to 60 mN/m or less. Further, the viscosity of the ink at 25° C. can be 1.0 mPa·s or more to 10.0 mPa·s or less. The pH of the ink at 25° C. can be 5.0 or more to 9.5 or less, or 6.0 or more to 9.0 or less.

### Reaction Liquid

The recording method of the present disclosure may include a reaction liquid applying step of applying an aqueous reaction liquid containing a reactant that reacts with an aqueous ink. In particular, the reaction liquid applying step can be performed before the ink applying step, or the ink applying step and the reaction liquid applying step can be performed at the same time. Hereinafter, each component and the like used in the reaction liquid will be described in detail.

### Reactant

The reaction liquid aggregates components (components containing an anionic group such as a resin) in the ink by reacting with the ink when coming into contact with the ink and contains a reactant. Due to the presence of the reactant, the state of presence of the components containing an anionic group in the ink is destabilized when the ink and the reactant come into contact with each other in the recording medium, and thus the aggregation of the ink can be promoted. Examples of the reactant include an organic acid, a polyvalent metal salt and a cationic resin.

Examples of the polyvalent metal ion constituting the polyvalent metal salt include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. In order to allow the reaction liquid to contain the polyvalent metal ion, a water-soluble polyvalent metal salt (may be a hydrate) formed by bonding a polyvalent metal ion and an anion to each other can be used. Examples of the anion constituting the polyvalent metal salt include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻, and organic anions such as HCOO⁻, (COO⁻)₂, COOH(COO⁻), CH₃COO⁻, C₂H₅COO—, CH₃CH(OH)COO⁻, C₂H₄(COO⁻)₂, C₆H₅COO⁻, C₆H₄(COO⁻)₂ and CH₃SO₃⁻. In a case where the polyvalent metal ion is used as the reactant, the content (% by mass) thereof in terms of the polyvalent metal salt in the reaction liquid can be 1.0% by mass or more to 40.0% by mass or less with respect to the total mass of the reaction liquid. In the present specification, “content (% by mass) of the polyvalent metal salt” in the reaction liquid in a case where the polyvalent metal salt is a hydrate denotes “content (% by mass) of an anhydride of the polyvalent metal salt” excluding water as a hydrate.

The reaction liquid containing an organic acid has a buffer capacity in an acidic region (pH of less than 7.0 and suitably 2.0 to 5.0) and thus efficiently aggregates anionic groups of the components present in the ink in the form of an acid. Examples of the organic acid include a monocarboxylic acid such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid or coumaric acid and a salt thereof, a dicarboxylic acid such as oxalic acid, malonic acid, succinic acid, glutaric acid, adipic acid, maleic acid, fumaric acid, itaconic acid, sebacic acid, phthalic acid, malic acid or tartaric acid, a salt thereof and a hydrogen salt thereof, a tricarboxylic acid such as citric acid or trimellitic acid, a salt thereof and a hydrogen salt thereof, and a tetracarboxylic acid such as pyromellitic acid, a salt thereof and a hydrogen salt thereof. When an organic acid is used as the reactant, the content (% by mass) of the organic acid in the reaction liquid can be 1.0% by mass or more to 50.0% by mass or less with respect to the total mass of the reaction liquid.

Examples of the cationic resin include a resin having a structure of primary to tertiary amines and a resin having a structure of a quaternary ammonium salt. Specific examples thereof include a resin having a structure of vinylamine, allylamine, vinylimidazole, vinylpyridine, dimethylaminoethyl methacrylate, ethyleneimine, guanidine, diallyldimethylammonium chloride or an alkylamine/epichlorohydrin condensate. In order to increase the solubility in the reaction liquid, the cationic resin and an acidic compound can be used in combination or the cationic resin can be subjected to a quaternization treatment. When the cationic resin is used as the reactant, the content (% by mass) of the cationic resin in the reaction liquid can be 0.1% by mass or more to 10.0% by mass or less with respect to the total mass of the reaction liquid.

### Aqueous Medium

The reaction liquid is an aqueous reaction liquid containing at least water as an aqueous medium. The aqueous medium used in the reaction liquid can contain the above-described water-soluble organic solvent that can be contained in the ink.

### Other Components

The reaction liquid may contain various other components as necessary. Examples of the other components include the above-described other components that can be contained in the ink.

### Physical Properties of Reaction Liquid

The reaction liquid is an aqueous reaction liquid to be applied to the ink jet method. Therefore, the physical property values thereof can be appropriately controlled from the viewpoint of the reliability. Specifically, the surface tension of the reaction liquid at 25° C. can be 20 mN/m or more to 60 mN/m or less. Further, the viscosity of the reaction liquid at 25° C. can be 1.0 mPa·s or more to 10.0 mPa·s or less. The pH of the reaction liquid at 25° C. can be 5.0 or more to 9.5 or less, or 6.0 or more to 9.0 or less.

### EXAMPLES

Hereinafter, the present disclosure will be described in more detail with reference to examples and comparative examples. The present disclosure is not limited to the following examples unless the gist thereof is overstepped. In regard to the component amount, “parts” and “%” are on a mass basis unless otherwise specified.

### Measurement of Physical Property Values

### Density

The densities of the particle and the resin particle were measured by a Gay-Lussac type specific gravity bottle (pycnometer) method in conformity with JIS Z 8807.

### Total Pore Volume

An aqueous dispersion liquid of the particle was dried and solidified at 60° C. to obtain a powder of the particle. About 0.10 g of the obtained particle was placed in a cell with an inner diameter of ⅜ inch, and the particle was dried by deaeration until the pressure reached 20 millitorr or less while the cell was heated to 60° C. using a sample pretreatment device (trade name “VacPrep 061”, manufactured by Micromeritics Instrument Corporation), thereby obtaining a sample. The pore volume distribution of the particle (inorganic particle) of the obtained sample was measured by a nitrogen adsorption and desorption method using a using a Micromeritics automatic specific surface area/pore distribution measuring device (trade name, “TRISTAR II” manufactured by Shimadzu Corporation). The measured value on the nitrogen desorption side from the measured pore volume distribution was defined as the total pore volume.

### Average Primary Particle Diameter D_{P}

An image of the sample was captured at a magnification of 100000 times using a scanning electron microscope (trade name “S-4700”, manufactured by Hitachi High-Tech Corporation). Further, the diameters of 100 circles circumscribing the primary particles were measured, and the average value thereof was calculated. The calculated average value was defined as an average primary particle diameter D_{P} of the particle.

### Glass Transition Temperature and Melting Point

The glass transition temperature Tg_{R} and the melting point Tm_{R} of the resin particle, and the melting point Tₘ of the particle were measured using a differential scanning calorimeter (DSC). First, the glass transition temperature of the resin particle will be described. 2 mg of the particle obtained by drying and solidifying the aqueous dispersion liquid of the resin particle at 60° C. was placed in an aluminum container, and the container was sealed to prepare a sample for measuring the glass transition temperature. The prepared sample was subjected to thermal analysis according to the following temperature programs using a differential scanning calorimeter (trade name “DSC-2500”, manufactured by TA Instruments). The glass transition temperature of the resin particle in the present specification is defined as follows. That is, in a temperature rise curve (horizontal axis: temperature, vertical axis: heat quantity) of the following temperature program (4) or (5), the temperature at an intersection between a straight line extending to a high temperature side through two points on a low temperature side curve and a tangent drawn at a point where the gradient of a step-wise change portion on the curve is maximized. The temperature determined as described above was defined as the glass transition temperature of the resin particle. The glass transition temperature Tg_{R} (° C.) of the resin particle was determined by performing the temperature program twice and used the value based on the measurement result obtained in the second cycle. Further, the melting point of the resin particle was measured in the same manner as in the following temperature programs (1) to (4) except that the upper limit of the temperature in the program (4) was changed, and the peak top of the endothermic peak of the temperature rise curve was defined as “melting point Tm of the particle”.

The glass transition temperature of the particle was measured in the same manner as the method employed for determining the glass transition temperature of resin particle. Further, the melting point of the particle was measured in the same manner as the resin particle in the following temperature programs (1) to (4) except that the upper limit of the temperature in the program (4) was changed, and the peak top of the endothermic peak of the temperature rise curve was defined as “melting point T_{M} of the particle”.

### Temperature Programs

(1) Temperature rise from −40° C. to 200° C. at 10° C./min
(2) Temperature maintained at 200° C. for 5 minutes
(3) Temperature drop from 200° C. to −40° C. at 10° C./min
(4) Temperature rise from −40° C. to 200° C. at 10° C./min
(5) Temperature rise from −40° C. to 150° C. at 10° C./min

### Volume-Based Cumulative 50% Particle Diameter

The volume-based cumulative 50% particle diameters D50 of the resin particle were measured with a particle diameter measuring device (trade name “UPA-EX150”, manufactured by Nikkiso Co., Ltd.) using a dynamic light scattering method.

### Preparation of Particle

The following particles (inorganic particles) were prepared. A mixing stirrer (trade name, “TK ROBOMIX”, manufactured by PRIMIX Corporation) was used as a disperser. The properties of the particles are listed in Table 1.

### Particle 1

200.76 parts of ion exchange water, 4.50 parts of 2,2′,2″-nitrilotriethanol and 94.74 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the particle 1 in which the content of the particle was 30.0%.

### Particle 2

131.50 parts of ion exchange water, 23.40 parts of a 1 mol/L potassium hydroxide aqueous solution and 68.18 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 300.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the particle 2 in which the content of the particle was 30.0%.

### Particle 3

151.81 parts of ion exchange water, 5.01 parts of an acrylic resin (trade name “ARON A-6330”, manufactured by Toagosei Co., Ltd., content of resin: 40.0 g), and 68.18 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 300.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the particle 3 in which the content of the particle was 20.0%.

### Particle 4

298.42 parts of ion exchange water, 23.40 parts of a 1 mol/L potassium hydroxide aqueous solution and 68.18 parts of silicon dioxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 1360 rpm for 1 hour. Thereafter, an appropriate amount of ion exchange water was added thereto, thereby obtaining an aqueous dispersion liquid of the particle 4 in which the content of the particle was 30.0%.

### Particle 5

200.76 parts of ion exchange water, 4.50 parts of 2,2′,2″-nitrilotriethanol and 94.74 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.10 mm were placed in a bead mill and dispersed at 1320 rpm for 5 hours. Thereafter, an appropriate amount of ion exchange water was added thereto, thereby obtaining an aqueous dispersion liquid of the particle 5 in which the content of the particle was 30.0%.

### Particle 6

1.5 parts of 4-amino-1,2-benzenedicarboxylic acid was added to a solution obtained by dissolving 5 parts of concentrated hydrochloric acid in 5.5 parts of water in a state where the solution was cooled to 5° C. Next, the solution was constantly maintained at a temperature of 10° C. or lower by placing the container containing the solution in an ice bath, and a solution obtained by dissolving 1.8 parts of sodium nitrite in 9 parts of water at 5° C. was added thereto. The resulting solution was further stirred for 15 minutes, and 6.0 parts of carbon black (trade name “BLACK PEARLS 880”, manufactured by Cabot Corporation) having a DBP oil absorption of 105 mL/100 g was added to the solution while the solution was stirred. Thereafter, the solution was further stirred for 15 minutes, the obtained slurry was filtered through filter paper (trade name “Standard Filter Paper No. 2”, manufactured by Advantec), and the particle was sufficiently washed with water. The particle was dried in an oven at 110° C. to prepare a self-dispersible pigment. Further, an appropriate amount of ion exchange water was added to the obtained self-dispersible pigment to disperse the pigment such that the content of the pigment reached 30.0%, thereby preparing a dispersion liquid. Thereafter, the counter ion of the anionic group was substituted with a potassium ion from a sodium ion using an ion exchange method. In this manner, an aqueous dispersion liquid of the particle 6 was obtained.

### Particle 7

350.00 parts of ion exchange water, 4.30 parts of an acrylic resin (ammonium salt type) aqueous solution (trade name “BYK-154”, manufactured by BYK-Chemie GmbH, content of resin: 42.0%) and 94.70 parts of calcium carbonate listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 1360 rpm for 5 hours. Thereafter, an appropriate amount of ion exchange water was added thereto, thereby obtaining an aqueous dispersion liquid of the particle 7 in which the content of the particle was 20.0%.

### Particle 8

200.76 parts of ion exchange water, 4.50 parts of 2,2′,2″-nitrilotriethanol and 94.74 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.10 mm were placed in the disperser and dispersed at 1360 rpm for 5 hours. Thereafter, an appropriate amount of ion exchange water was added thereto, thereby obtaining an aqueous dispersion liquid of the particle 8 in which the content of the particle was 30.0%.

### Particle 9

139.94 parts of ion exchange water, 16.88 parts of a resin dispersant (trade name “ARON A-6330”, manufactured by Toagosei Co., Ltd., acrylic water-soluble resin, content of resin: 40.0 g), and 68.18 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 300.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the particle 9 in which the content of the particle was 30.0%.

### Particle 10

205.80 parts of ion exchange water, 1.20 parts of acetic acid and 93.00 parts of aluminum oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 1360 rpm for 1 hour. Thereafter, an appropriate amount of ion exchange water was added thereto, thereby obtaining an aqueous dispersion liquid of the particle 10 in which the content of the particle was 30.0%.

### Particle 11

131.50 parts of ion exchange water, 23.40 parts of a 1 mol/L potassium hydroxide aqueous solution and 68.18 parts of barium sulfate listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the particle 11 in which the content of the particle was 30.0%.

### Particle 12

An acrylic crosslinked resin (trade name “EPOSTAR MX030W”, manufactured by NIPPON SHOKUBAI CO., LTD., content of resin: 10.0%) was used as an aqueous dispersion liquid of the particle 12.

### Particle 13

A hollow particle (trade name “ROPAQUE HP 1055”, manufactured by Dow Inc., content of resin: 26.5%) was used as an aqueous dispersion liquid of the particle 13.

### Particle 14

200.76 parts of ion exchange water, 4.50 parts of 2,2′,2″-nitrilotriethanol and 94.74 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.10 mm were placed in a bead mill and dispersed at 1250 rpm for 5 hours. Thereafter, an appropriate amount of ion exchange water was added thereto, thereby obtaining an aqueous dispersion liquid of the particle 14 in which the content of the particle was 30.0%.

### Particle 15

200.76 parts of ion exchange water, 4.50 parts of 2,2′,2″-nitrilotriethanol and 94.74 parts of titanium oxide listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.10 mm were placed in a bead mill and dispersed at 1000 rpm for 5 hours. Thereafter, an appropriate amount of ion exchange water was added thereto, thereby obtaining an aqueous dispersion liquid of the particle 15 in which the content of the particle was 30.0%.

### Particle 16

An acrylic resin (trade name “JONCRYL 683”, manufactured by BASF SE) was added to sodium hydroxide in an amount equimolar to the acid value, and the mixture was dissolved in ion exchange water to prepare an aqueous solution of a resin dispersant in which the content of the resin was 20.0%. A mixture of 10.0 parts of a pigment (C.I. Pigment Blue 15:3), 25.0 parts of the resin dispersant, and 65.0 parts of water was placed in a sand grinder, and subjected to a dispersion treatment for 1 hour. Thereafter, the mixture was subjected to a centrifugation treatment and pressurized and filtered through a cellulose acetate filter (manufactured by Advantec) having a pore size of 3.0 μm, and an appropriate amount of ion exchange water was added thereto, thereby obtaining an aqueous dispersion liquid of the particle 16 in which the content of the particle was 10.0% and the content of the resin dispersant was 5.0%.

TABLE 1
Properties of particle

| | | | Content | | | | | Total |
|---|---|---|---|---|---|---|---|---|
| | | | of | | | | Density | pore |
| | | | particle | D_{P} | Tg_{P} | Tm_{P} | ρ_{P} | volume |
| Particle | Trade name | Material | (%) | (nm) | (° C.) | (° C.) | (g/cm³) | (mL/g) |
| 1 | Titanium oxide fine particle | Titanium oxide | 30.0 | 10 | — | 1800 | 4.20 | 0.24 |
| | (trade name “MT-100WP”, | | | | | | | |
| | manufactured by Tayca Corporation) | | | | | | | |
| 2 | Titanium oxide | Titanium oxide | 30.0 | 12 | — | 1800 | 4.20 | 0.28 |
| | (trade name “JR-403”, manufactured | | | | | | | |
| | by Tayca Corporation) | | | | | | | |
| 3 | Titanium oxide | Titanium oxide | 30.0 | 11 | — | 1800 | 4.20 | 0.20 |
| | (trade name “JR-403”, manufactured | | | | | | | |
| | by Tayca Corporation) | | | | | | | |
| 4 | Hydrophilic fumed silica | Silicon dioxide | 20.0 | 7 | — | 1700 | 2.20 | 0.72 |
| | (trade name “AEROSIL 200”, | | | | | | | |
| | manufactured by Nippon Aerosil Co., | | | | | | | |
| | Ltd.) | | | | | | | |
| 5 | Titanium oxide | Titanium oxide | 30.0 | 150 | — | 1800 | 4.20 | 0.08 |
| | (trade name “JR-403”, manufactured | | | | | | | |
| | by Tayca Corporation) | | | | | | | |
| 6 | — | Self-dispersible pigment | 30.0 | 13 | — | 3550 | 2.00 | 0.35 |
| | | (carbon black) | | | | | | |
| 7 | Light calcium carbonate | Calcium carbonate | 20.0 | 30 | — | 825 | 2.70 | 0.26 |
| | (trade name “VISCAL”, manufactured | | | | | | | |
| | by NEW LIME CO., LTD.) | | | | | | | |
| 8 | Titanium oxide | Titanium oxide | 30.0 | 144 | — | 1800 | 4.20 | 0.08 |
| | (trade name “JR-403”, manufactured | | | | | | | |
| | by Tayca Corporation) | | | | | | | |
| 9 | Titanium oxide | Titanium oxide | 30.0 | 9 | — | 1800 | 4.20 | 0.10 |
| | (trade name “JR-403”, manufactured | | | | | | | |
| | by Tayca Corporation) | | | | | | | |
| 10 | Fumed alumina | Aluminum oxide | 30.0 | 13 | — | 2070 | 3.40 | 0.23 |
| | (trade name “AEROXIDE Alu C”, | | | | | | | |
| | manufactured by Nippon Aerosil Co., | | | | | | | |
| | Ltd.) | | | | | | | |
| 11 | Ultrafine barium sulfate particle | Barium sulfate | 30.0 | 16 | — | 1580 | 4.50 | 0.13 |
| | (trade name “BARIFINE BF-40”, | | | | | | | |
| | manufactured by SAKAI CHEMICAL | | | | | | | |
| | INDUSTRY CO., LTD.) | | | | | | | |
| 12 | Aqueous dispersion of acrylic | Crosslinked | 10.0 | 40 | 280 | — | 1.20 | 0.08 |
| | crosslinked product | acrylic resin particle | | | | | | |
| | (trade name “EPOSTAR MX030W”, | | | | | | | |
| | manufactured by NIPPON | | | | | | | |
| | SHOKUBAI CO., LTD.) | | | | | | | |
| 13 | Aqueous dispersion of hollow | Hollow acrylic | 26.5 | 1000 | 106 | — | 1.20 | 0.02 |
| | spherical particle | resin particle | | | | | | |
| | (trade name “ROPAQUE HP-1055M”, | | | | | | | |
| | manufactured by Dow Inc.) | | | | | | | |
| 14 | Titanium oxide | Titanium oxide | 30.0 | 165 | — | 1800 | 4.20 | 0.06 |
| | (trade name “JR-403”, manufactured | | | | | | | |
| | by Tayca Corporation) | | | | | | | |
| 15 | Titanium oxide | Titanium oxide | 30.0 | 250 | — | 1800 | 4.20 | 0.02 |
| | (trade name “JR-403”, manufactured | | | | | | | |
| | by Tayca Corporation) | | | | | | | |
| 16 | — | Resin dispersion pigment | 10.0 | 160 | — | 480 | 1.50 | 0.02 |
| | | (C.I. Pigment Blue 15:3) | | | | | | |

### Preparation of Resin Particle

The following resin particles were prepared. The properties of the first resin particle are listed in Table 2, and the properties of the second resin particle are listed in Table 3.

### First Resin Particle 1

0.2 parts of potassium persulfate and 74.0 parts of ion exchange water were mixed with each other to prepare a solution. Further, 1.5 parts of acrylic acid, 2.5 parts of 2-ethylhexyl acrylate, 30.0 parts of methyl methacrylate, 5.0 parts of styrene and 0.3 parts of a reactive surfactant were mixed with each other to prepare an emulsified product. A nonionic surfactant (trade name “ADEKA REASOAP ER-20”, manufactured by Adeka Corporation, number of ethylene oxide units: 20) was used as the reactive surfactant. The emulsified product was added dropwise to the solution over 1 hour in a nitrogen atmosphere, and the solution was polymerized while being stirred at 80° C. and further stirred for 2 hours. The solution was cooled to 25° C., ion exchange water and a potassium hydroxide aqueous solution were added to the solution to adjust pH to 8.0, and the solid content was adjusted with an appropriate amount of ion exchange water, thereby obtaining an aqueous dispersion liquid of the first resin particle 1 with the properties listed in Table 2.

### First Resin Particle 2

An aqueous dispersion liquid (trade name “SUPERFLEX 300”, manufactured by DKS Co., Ltd.) of a polyurethane resin particle was used as an aqueous dispersion liquid of the first resin particle 2.

### First Resin Particles 3 and 4

Aqueous dispersion liquids of the first resin particles 3 and 4, in which the content of the resin particle was 30.0%, were obtained by the same procedure as that for the first resin particle except that the amount of the reactive surfactant to be used and the stirring speed were changed.

### First Resin Particle 5

A mixture of 498 parts of terephthalic acid, 498 parts of isophthalic acid, 876 parts of adipic acid, and 2280 parts of bisphenol A was added to a reaction container placed in an autoclave and heated at 250° C. and 13 kPa for 6 hours to carry out an esterification reaction. Next, 0.8 parts of antimony trioxide and 0.15 parts of phosphoric acid were added thereto as catalysts, the mixture was heated to 270° C., and the pressure inside the reaction container was gradually reduced to 13 Pa over 1.5 hours. The polycondensation reaction was continued for 4 hours in a state of maintaining the temperature at 270° C. and the reduced pressure at 13 Pa, and the pressure was returned to the normal pressure by introducing nitrogen gas into the reaction container. The temperature was decreased to 265° C., 15 parts of trimellitic acid was added to the mixture, and the mixture was heated at 265° C. for 2 hours to carry out a polymerization reaction, thereby obtaining a polyester resin 1.

A stirrer (trade name “Tornado Standard SM-101”, manufactured by AS ONE Corporation) was set in a 2 L beaker. 150 parts of the polyester resin 1 obtained above and 350 parts of tetrahydrofuran were added to the beaker, and the mixture was stirred at 25° C. to dissolve the resin. Next, a 5% sodium hydroxide aqueous solution was added thereto such that the neutralization rate of the acid group of the resin reached 100%, and the solution was stirred for 30 minutes, thereby obtaining a slurry. 700 parts of deionized water was added dropwise to the beaker at a rate of 20 mL/min while the solution was stirred at 25° C. and 150 rpm. After the solution was heated to 60° C., tetrahydrofuran was distilled off under reduced pressure, and some water was also distilled off. Next, the beaker was placed in a water bath at 85° C., and the contents were stirred for 2 hours and subjected to a heat treatment. The contents were filtered through a 150 mesh wire net, and an appropriate amount of ion exchange water was added thereto, thereby obtaining an aqueous dispersion liquid of the first resin particle 5 in which the content of the resin was 30.0%,

### First Resin Particle 6

250 parts of sebacic acid, 50 parts of terephthalic acid and 170 parts of 1,6-hexanediol were mixed and heated at 190° C. for 1 hour in an autoclave to carry out an esterification reaction. Next, 0.01 parts of tetrabutyl orthotitanate was added thereto as a catalyst, and the internal temperature was increased to 240° C. over 6 hours to polymerize the mixture while generated water was distilled off, thereby obtaining a polyester resin 2. 50 parts of the obtained polyester resin 2 was added to a 300 mL four neck flask equipped with a nitrogen introduction pipe, a stirrer and a thermocouple. 50 parts of methyl ethyl ketone was added, and the mixture was heated to 40° C. in a nitrogen stream to dissolve the polyester resin. 1.2 parts of triethylamine was further added thereto, the mixture was stirred for 1 hour, 106 parts of ion exchange water was added dropwise to the mixture at a rate of 7.5 g/min, and the resulting mixture was stirred for 30 minutes. Thereafter, methyl ethyl ketone was removed under reduced pressure, thereby obtaining an aqueous dispersion liquid of the first resin particle 6.

### First Resin Particle 7

An aqueous dispersion liquid of an acrylic resin particle (trade name “JONCRYL 1680-E”, manufactured by BASF SE) was used as an aqueous dispersion liquid of the first resin particle 7.

TABLE 2
Properties of first resin particle

| First resin | Content of resin particle | D50_{R1} | Tg_{R1} | Tm_{R1} | ρ_{R1} |
|---|---|---|---|---|---|
| particle | (%) | (nm) | (° C.) | (° C.) | (g/cm³) |
| 1 | 30.0 | 100 | 80 | — | 1.20 |
| 2 | 30.0 | 200 | 80 | — | 1.20 |
| 3 | 30.0 | 400 | 80 | — | 1.20 |
| 4 | 30.0 | 150 | — | 80 | 1.30 |
| 5 | 30.0 | 190 | — | 75 | 1.00 |
| 6 | 35.0 | 90 | −12 | — | 1.00 |
| 7 | 46.5 | 170 | 56 | — | 1.20 |

### Second Resin Particle 1

32.0 parts of a wax (Fischer-Tropsch wax), 6.0 parts of a nonionic dispersant (polyoxyethylene cetyl ether, number of ethylene oxide units: 10) and 1.0 parts of an anionic dispersant (ethylene acrylic acid) were mixed with each other. Thereafter, the resin particle was dispersed by appropriately adjusting the temperature and the pressure, thereby obtaining an aqueous dispersion liquid of the second resin particle 1.

### Second Resin Particle 2

An aqueous dispersion liquid of the second resin particle 2 was obtained by the same method as the method for the aqueous dispersion liquid of the second resin particle 1 except that the nonionic dispersant was changed to polyoxyethylene oleyl ether (number of ethylene oxide units: 30).

### Second Resin Particle 3

An aqueous dispersion liquid of the second resin particle 3 was obtained by the same method as the method for the aqueous dispersion liquid of the second resin particle 1 except that the wax was changed to polyethylene wax.

### Second Resin Particle 4

32.0 parts of a wax (Fischer-Tropsch wax) and 1.0 parts of an anionic dispersant (ethylene acrylic acid) were mixed with each other. Thereafter, the resin particle was dispersed by appropriately adjusting the temperature and the pressure, thereby obtaining an aqueous dispersion liquid of the second resin particle 4.

### Second Resin Particle 5

As the aqueous dispersion of the second resin particle 5, a polystyrene resin emulsion (trade name, “PS20V”, manufactured by NANO-MIR CO., LTD.) concentrated to contain 30.0% resin particle was used.

### Second Resin Particle 6

An aqueous dispersion liquid of the second resin particle 6 was obtained by the same method as the method for the aqueous dispersion liquid of the second resin particle 1 except that the wax was changed to paraffin wax.

### Second Resin Particle 7

An aqueous dispersion liquid of the second resin particle 7 was obtained by the same method as the method for the aqueous dispersion liquid of the second resin particle 1 except that the wax was changed to rosin ester (trade name “SUPER ESTER A-75”, manufactured by Arakawa Chemical Industries, Ltd.).

### Second Resin Particle 8

An alkyl ketene dimer emulsion (trade name “AD1638”, manufactured by SEIKO PMC CORPORATION) was used as an aqueous dispersion liquid of the second resin particle 8.

### Second Resin Particle 9

A polyvinyl chloride resin emulsion (trade name “VINYBLAN 700”, manufactured by Nissin Chemical Industry Co., Ltd.) was used as an aqueous dispersion liquid of the second resin particle 9.

### Second Resin Particle 10

A polyethylene wax dispersion (trade name “HORDAMER PE02”, manufactured by BASF SE) was used as an aqueous dispersion liquid of the second resin particle 10.

TABLE 3
Properties of second resin particle

| | | | | Content | | | | |
|---|---|---|---|---|---|---|---|---|
| Second | | | | of resin | | | | |
| resin | | Nonionic | Anionic | particle | D_{R2} | Tg_{R2} | Tm_{R2} | ρ_{R2} |
| particle | Material | dispersant | dispersant | (%) | (nm) | (° C.) | (° C.) | (g/cm³) |
| 1 | Fischer-Tropsch wax | Present | Present | 30.0 | 100-200 | — | 90 | 0.94 |
| 2 | Fischer-Tropsch wax | Present | Present | 30.0 | 100-200 | — | 90 | 0.94 |
| 3 | Polyethylene wax | Present | Present | 30.0 | 100-200 | — | 90 | 0.95 |
| 4 | Fischer-Tropsch wax | Absent | Present | 30.0 | 100-200 | — | 90 | 0.94 |
| 5 | Polystyrene resin | Absent | Present | 30.0 | 200 | — | — | 1.00 |
| 6 | Paraffin wax | Present | Present | 35.0 | 100-200 | — | 75 | 0.94 |
| 7 | Rosin ester | Present | Present | 30.0 | 100-200 | — | 77 | 1.10 |
| 8 | Alkyl ketene dimer | Present | Present | 30.0 | 570 | — | 70-80 | 0.85 |
| 9 | Polyvinyl chloride | Absent | Present | 30.0 | 30 | 70 | — | 1.40 |
| 10 | Polyethylene wax | Absent | Present | 40.0 | 116 | — | 95 | 0.97 |

### Preparation of Ink

The components (unit: %) listed in the middle columns of Tables 4 to 7 were mixed, potassium hydroxide (included in the amount of ion exchange water used) was added thereto, and the pH of the ink was adjusted to be in a range of 7 to 9. The mixture was pressurized and filtered through a microfilter (manufactured by FUJIFILM Corporation) having a pore size of 3.0 μm to prepare each ink. In Tables 4 to 7, “SURFYNOL 465” is the trade name of a nonionic surfactant (acetylene glycol ethylene oxide adduct, manufactured by Nissin Chemical Industry Co., Ltd.). The properties of each ink are listed in the lower columns of Tables 4 to 7.

TABLE 4
Composition and properties of ink

| | Ink | | | | | | | | | | |
|---|---|---|---|---|---|---|---|---|---|---|---|
| | 1 | 2 | 3 | 4 | 5 | 6 | 7 | 8 | 9 | 10 | 11 |
| Type of particle | 1 | 2 | 3 | 1 | 1 | 1 | 1 | 1 | 4 | 5 | 1 |
| Type of first resin particle | 1 | 1 | 1 | 2 | 3 | 4 | 1 | 1 | 1 | 1 | 5 |
| Type of second resin particle | 1 | 1 | 1 | 1 | 1 | 1 | 2 | 3 | 1 | 1 | 1 |
| Aqueous dispersion liquid of particle | 45.0 | 45.0 | 45.0 | 45.0 | 45.0 | 45.0 | 45.0 | 45.0 | 35.0 | 45.0 | 45.0 |
| Aqueous dispersion liquid of first resin particle | 26.0 | 26.0 | 26.0 | 26.0 | 26.0 | 27.5 | 26.0 | 25.0 | 25.0 | 25.0 | 21.4 |
| Aqueous dispersion liquid of second resin | 6.8 | 6.8 | 6.8 | 6.8 | 6.8 | 6.8 | 5.8 | 6.8 | 6.8 | 6.8 | 6.8 |
| particle | | | | | | | | | | | |
| 1,2-Butanediol | 15.0 | 15.0 | 15.0 | 15.0 | 15.0 | 15.0 | 15.0 | 15.0 | 15.0 | 15.0 | 15.0 |
| Glycerin | | | | | | | | | | | |
| SURFYNOL 465 | 0.5 | 0.5 | 0.5 | 0.5 | 0.5 | 0.5 | 0.5 | 0.5 | 0.5 | 0.5 | 0.5 |
| Ion exchange water | 6.7 | 6.7 | 6.7 | 6.7 | 6.7 | 5.2 | 7.7 | 7.7 | 17.7 | 7.7 | 11.3 |
| Value of ρ_{P}/ρ_{R1} (times) | 3.5 | 3.5 | 3.5 | 3.5 | 3.5 | 3.2 | 3.5 | 3.5 | 1.8 | 3.5 | 4.2 |
| Value of ρR₁/ρ_{R2} (times) | 1.3 | 1.3 | 1.3 | 1.3 | 1.3 | 1.4 | 1.3 | 1.3 | 1.3 | 1.3 | 1.1 |
| Content C_{P} of particle (%) | 13.5 | 13.5 | 13.5 | 13.5 | 13.5 | 13.5 | 13.5 | 13.5 | 17.5 | 13.5 | 13.5 |
| Content C_{R1} of first resin particle (%) | 7.8 | 7.8 | 7.8 | 7.8 | 7.8 | 8.3 | 7.8 | 7.5 | 7.5 | 7.5 | 6.4 |
| Content C_{R2} of second resin particle (%) | 2.0 | 2.0 | 2.0 | 2.0 | 2.0 | 2.0 | 1.7 | 2.0 | 2.0 | 2.0 | 2.0 |
| Content V_{P} of particle (% by volume) | 3.2 | 3.2 | 3.2 | 3.2 | 3.2 | 3.2 | 3.2 | 3.2 | 3.2 | 3.2 | 3.2 |
| Content V_{R1} of first resin particle (% by volume) | 6.5 | 6.5 | 6.5 | 6.5 | 6.5 | 6.3 | 6.5 | 6.3 | 6.3 | 6.3 | 6.4 |
| Content V_{R2} of second resin particle (% by | 2.2 | 2.2 | 2.2 | 2.2 | 2.2 | 2.2 | 1.9 | 2.1 | 2.2 | 2.2 | 2.2 |
| volume) | | | | | | | | | | | |
| Value of V_{R1}/V_{P} (times) | 2.0 | 2.0 | 2.0 | 2.0 | 2.0 | 2.0 | 2.0 | 2.0 | 2.0 | 2.0 | 2.0 |
| Value of V_{R2}/V_{R1} (times) | 0.3 | 0.3 | 0.3 | 0.3 | 0.3 | 0.3 | 0.3 | 0.3 | 0.3 | 0.3 | 0.3 |

TABLE 5
Composition and properties of ink

| | Ink | | | | | | | | | | |
|---|---|---|---|---|---|---|---|---|---|---|---|
| | 12 | 13 | 14 | 15 | 16 | 17 | 18 | 19 | 20 | 21 | 22 |
| Type of particle | 6 | 7 | 8 | 9 | 1 | 1 | 1 | 1 | 1 | 1 | 1 |
| Type of first resin particle | 6 | 4 | 1 | 1 | 1 | 1 | 1 | 1 | 1 | 1 | 1 |
| Type of second resin particle | 1 | 1 | 1 | 1 | 1 | 1 | 1 | 1 | 1 | 1 | 1 |
| Aqueous dispersion liquid of particle | 21.5 | 45.0 | 45.0 | 45.0 | 51.0 | 50.0 | 20.0 | 21.5 | 21.5 | 45.0 | 45.0 |
| Aqueous dispersion liquid of first resin particle | 20.0 | 27.5 | 25.0 | 26.0 | 17.0 | 18.0 | 23.0 | 30.0 | 31.0 | 25.0 | 25.0 |
| Aqueous dispersion liquid of second resin | 6.8 | 6.8 | 6.8 | 6.8 | 6.8 | 7.0 | 6.8 | 6.8 | 6.8 | 1.0 | 1.2 |
| particle | | | | | | | | | | | |
| 1,2-Butanediol | 15.0 | 15.0 | 15.0 | 15.0 | 15.0 | 15.0 | 15.0 | 15.0 | 15.0 | 15.0 | 15.0 |
| Glycerin | | | | | | | | | | | |
| SURFYNOL 465 | 0.5 | 0.5 | 0.5 | 0.5 | 0.5 | 0.5 | 0.5 | 0.5 | 0.5 | 0.5 | 0.5 |
| Ion exchange water | 36.2 | 5.2 | 7.7 | 6.7 | 9.7 | 9.5 | 34.7 | 26.2 | 25.2 | 13.5 | 13.3 |
| Value of ρ_{P}/ρ_{R1} (times) | 2.0 | 2.1 | 3.5 | 3.5 | 3.5 | 3.5 | 3.5 | 3.5 | 3.5 | 3.5 | 3.5 |
| Value of ρ_{R1}/ρ_{R2} (times) | 1.1 | 1.4 | 1.3 | 1.3 | 1.3 | 1.3 | 1.3 | 1.3 | 1.3 | 1.3 | 1.3 |
| Content C_{P} of particle (%) | 6.5 | 9.0 | 13.5 | 13.5 | 15.3 | 15.0 | 6.0 | 6.5 | 6.5 | 13.5 | 13.5 |
| Content CR₁ of first resin particle (%) | 13.0 | 8.3 | 7.5 | 7.8 | 5.1 | 5.4 | 6.9 | 9.0 | 9.3 | 7.5 | 7.5 |
| Content C_{R2} of second resin particle (%) | 2.0 | 2.0 | 2.0 | 2.0 | 2.0 | 2.1 | 2.0 | 2.0 | 2.0 | 0.3 | 0.4 |
| Content V_{P} of particle (% by volume) | 3.2 | 3.3 | 3.2 | 3.2 | 3.6 | 3.6 | 1.4 | 1.5 | 1.5 | 3.2 | 3.2 |
| Content V_{R1} of first resin particle (% by volume) | 7.0 | 6.3 | 6.3 | 6.5 | 4.3 | 4.5 | 5.8 | 7.5 | 7.8 | 6.3 | 6.3 |
| Content V_{R2} of second resin particle (% by | 2.2 | 2.2 | 2.2 | 2.2 | 2.2 | 2.2 | 2.2 | 2.2 | 2.2 | 0.3 | 0.4 |
| volume) | | | | | | | | | | | |
| Value of V_{R1}/V_{P} (times) | 2.2 | 1.9 | 2.0 | 2.0 | 1.2 | 1.3 | 4.1 | 5.0 | 5.2 | 2.0 | 2.0 |
| Value of V_{R2}/V_{R1} (times) | 0.3 | 0.3 | 0.3 | 0.3 | 0.5 | 0.5 | 0.4 | 0.3 | 0.3 | 0.05 | 0.06 |

TABLE 6
Composition and properties of ink

| | Ink | | | | | | | | | | |
|---|---|---|---|---|---|---|---|---|---|---|---|
| | 23 | 24 | 25 | 26 | 27 | 28 | 29 | 30 | 31 | 32 | 33 |
| Type of particle | 1 | 1 | 7 | 10 | 11 | 1 | 1 | 1 | 1 | 1 | 12 |
| Type of first resin particle | 1 | 1 | 1 | 1 | 6 | 1 | 1 | 1 | 1 | 1 | 1 |
| Type of second resin particle | 1 | 1 | 1 | 1 | 1 | 4 | 5 | 6 | 7 | 8 | 5 |
| Aqueous dispersion liquid of particle | 45.0 | 45.0 | 45.0 | 45.0 | 45.0 | 45.0 | 45.0 | 45.0 | 45.0 | 45.0 | 55.0 |
| Aqueous dispersion liquid of first resin particle | 25.0 | 25.0 | 24.0 | 26.0 | 21.4 | 25.0 | 25.0 | 26.0 | 25.0 | 25.0 | 22.0 |
| Aqueous dispersion liquid of second resin | 11.8 | 13.0 | 6.8 | 6.8 | 6.8 | 6.8 | 6.8 | 5.8 | 6.8 | 6.8 | 1.0 |
| particle | | | | | | | | | | | |
| 1,2-Butanediol | 15.0 | 15.0 | 15.0 | 15.0 | 15.0 | 15.0 | 15.0 | 15.0 | 15.0 | 15.0 | 15.0 |
| Glycerin | | | | | | | | | | | |
| SURFYNOL 465 | 0.5 | 0.5 | 0.5 | 0.5 | 0.5 | 0.5 | 0.5 | 0.5 | 0.5 | 0.5 | 0.5 |
| Ion exchange water | 2.7 | 1.5 | 8.7 | 6.7 | 11.3 | 7.7 | 7.7 | 7.7 | 7.7 | 7.7 | 6.5 |
| Value of ρ_{P}/ρ_{R1} (times) | 3.5 | 3.5 | 2.3 | 2.8 | 4.5 | 3.5 | 3.5 | 3.5 | 3.5 | 3.5 | 1.0 |
| Value of ρ_{R1}/ρ_{R2} (times) | 1.3 | 1.3 | 1.3 | 1.3 | 1.1 | 1.3 | 1.2 | 1.3 | 1.1 | 1.4 | 1.2 |
| Content C_{P} of particle (%) | 13.5 | 13.5 | 9.0 | 13.5 | 13.5 | 13.5 | 13.5 | 13.5 | 13.5 | 13.5 | 5.5 |
| Content CR₁ of first resin particle (%) | 7.5 | 7.5 | 7.2 | 7.8 | 13.9 | 7.5 | 7.5 | 7.8 | 7.5 | 7.5 | 6.6 |
| Content C_{R2} of second resin particle (%) | 3.5 | 3.9 | 2.0 | 2.0 | 2.0 | 2.0 | 2.0 | 3.8 | 2.0 | 2.0 | 0.3 |
| Content V_{P} of particle (% by volume) | 3.2 | 3.2 | 3.3 | 4.0 | 3.0 | 3.2 | 3.2 | 3.2 | 3.2 | 3.2 | 4.6 |
| Content V_{R1} of first resin particle (% by volume) | 6.3 | 6.3 | 6.0 | 6.5 | 7.5 | 6.3 | 6.3 | 6.5 | 6.3 | 6.3 | 5.5 |
| Content V_{R2} of second resin particle (% by | 3.8 | 4.1 | 2.2 | 2.2 | 2.2 | 2.2 | 2.0 | 2.2 | 1.9 | 2.4 | 0.3 |
| volume) | | | | | | | | | | | |
| Value of V_{R1}/V_{P} (times) | 2.0 | 2.0 | 1.8 | 1.6 | 2.5 | 2.0 | 2.0 | 2.0 | 2.0 | 2.0 | 1.2 |
| Value of V_{R2}/V_{R1} (times) | 0.6 | 0.7 | 0.4 | 0.3 | 0.3 | 0.3 | 0.3 | 0.3 | 0.3 | 0.4 | 0.1 |

TABLE 7
Composition and properties of ink

| | Ink | | | | | | | | |
|---|---|---|---|---|---|---|---|---|---|
| | 34 | 35 | 36 | 37 | 38 | 39 | 40 | 41 | 42 |
| Type of particle | 12 | 1 | 12 | 14 | 1 | 1 | 15 | 13 | 16 |
| | 13 | | | | | | | | |
| Type of first resin particle | 1 | 1 | 5 | 1 | 6 | 1 | 1 | 6 | 7 |
| Type of second resin particle | 5 | — | 1 | 1 | 5 | 9 | 1 | — | 10 |
| Aqueous dispersion liquid of particle | 55.0 | 45.0 | 40.0 | 45.0 | 45.0 | 45.0 | 45.0 | 30.0 | 40.0 |
| | 5.5 | | | | | | | | |
| Aqueous dispersion liquid of first resin particle | 22.0 | 25.0 | 21.4 | 25.0 | 25.0 | 25.0 | 25.0 | 21.4 | 10.1 |
| Aqueous dispersion liquid of second resin particle | 1.0 | | 6.8 | 6.8 | 6.8 | 6.8 | 6.8 | | 2.5 |
| 1,2-Butanediol | 15.0 | 15.0 | 15.0 | 15.0 | 15.0 | 15.0 | 15.0 | | 19.0 |
| Glycerin | | | | | | | | 15.0 | |
| SURFYNOL 465 | 0.5 | 0.5 | 0.5 | 0.5 | 0.5 | 0.5 | 0.5 | 0.5 | 0.5 |
| Ion exchange water | 1.0 | 14.5 | 16.3 | 7.7 | 7.7 | 7.7 | 7.7 | 33.1 | 27.9 |
| Value of ρ_{P}/ρ_{R1} (times) | 1.0 | 3.5 | 1.2 | 3.5 | 4.2 | 3.5 | 3.5 | 1.2 | 1.3 |
| Value of ρ_{R1}/ρ_{R2} (times) | 1.2 | — | 1.1 | 1.3 | 1.0 | 0.9 | 1.3 | — | 1.2 |
| Content C_{P} of particle (%) | 7.0 | 13.5 | 4.0 | 13.5 | 13.5 | 13.5 | 13.5 | 8.0 | 4.0 |
| Content CR₁ of first resin particle (%) | 6.6 | 7.5 | 6.4 | 7.5 | 16.3 | 7.5 | 7.5 | 13.9 | 4.7 |
| Content C_{R2} of second resin particle (%) | 0.3 | 0.0 | 2.0 | 2.0 | 2.0 | 2.0 | 2.0 | 0.0 | 1.0 |
| Content V_{P} of particle (% by volume) | 5.8 | 3.2 | 3.3 | 3.2 | 3.2 | 3.2 | 3.2 | 6.6 | 2.7 |
| Content V_{R1} of first resin particle (% by volume) | 5.5 | 6.3 | 6.4 | 6.3 | 8.8 | 6.3 | 6.3 | 7.5 | 3.9 |
| Content V_{R2} of second resin particle (% by volume) | 0.3 | 0.0 | 2.2 | 2.2 | 2.0 | 1.5 | 2.2 | 0.0 | 1.0 |
| Value of V_{R1}/V_{P} (times) | 0.9 | 2.0 | 1.9 | 2.0 | 2.8 | 2.0 | 2.0 | 1.1 | 1.4 |
| Value of V_{R2}/V_{R1} (times) | 0.1 | 0.0 | 0.3 | 0.3 | 0.2 | 0.2 | 0.3 | 0.0 | 0.3 |

### Preparation of Reaction Liquid

### Reaction Liquid 1

20.0 parts of a magnesium sulfate heptahydrate, 20.0 parts of 1,2-butanediol, 0.5 parts of a nonionic surfactant (trade name, “SURFYNOL 465”, manufactured by Nissin Chemical Industry Co., Ltd.) and 59.5 parts of ion exchange water were mixed with each other and sufficiently stirred. Thereafter, the mixture was pressurized and filtered through a cellulose acetate filter (manufactured by Advantec) having a pore size of 3.0 pin, thereby preparing a reaction liquid 1.

### Reaction Liquid 2

20.0 parts of a magnesium sulfate heptahydrate, 37.7 parts of a liquid containing a cationic resin, 0.5 parts of a nonionic surfactant (trade name, “SURFYNOL 465”, manufactured by Nissin Chemical Industry Co., Ltd.) and 41.5 parts of ion exchange water were mixed with each other and sufficiently stirred. As the cationic resin, “UNISENSE FPA100L” (trade name, manufactured by SENKA Corporation, content of cationic resin: 27.0%) was used. Thereafter, the mixture was pressurized and filtered through a cellulose acetate filter (manufactured by Advantec) having a pore size of 3.0 μm, thereby preparing a reaction liquid 2.

### Preparation of Recording Medium

The following recording media were prepared.
Recording medium 1: polyethylene terephthalate film (trade name “Ultra-transparent PET film GIY-0305”, manufactured by LINTEC Corporation, water absorption amount from start of contact to 30 msec^{1/2} is 10 mL/m² or less in Bristow method)
Recording medium 2: aramid film (trade name “MICTRON #12-GF10”, manufactured by Toray Industries, Inc., water absorption amount from start of contact to 30 msec^{1/2} is 10 g/m² or less in Bristow method)

### Evaluation

The following items were evaluated using the reaction liquids and the inks obtained above. In the present disclosure, “AA”, “A” and “B” were determined to be acceptable levels and “C” was determined to be an unacceptable level in the evaluation criteria for each item described below. The evaluation results are listed in Table 8.

### Recording of Image for Evaluation

The reaction liquid and the ink listed in Table 8 were used as a set to record an image for evaluation (solid image) under the following conditions. In the present example, the recording duty of the solid image recorded under the condition of applying 8 liquid droplets (the reaction liquid or the ink) with a mass of 3.5 ng per droplet to a unit area of 1/600 inch× 1/600 inch was defined as 100%. The reaction liquid and the ink were applied in this order to the recording medium listed in Table 8 using the recording apparatus listed in Table 8 such that the reaction liquid and the ink overlapped each other, to record a solid image with a size of 50 mm×50 mm. The recording duty of the reaction liquid was set to 40%, and the recording duty of the ink was set to 400%.
Recording apparatus 1: A cartridge filled with the reaction liquid was set in the reaction liquid applying device 1102 of the ink jet recording apparatus having the configuration shown in FIG. 4, and a cartridge filled with the ink was set in the ink applying device 1103. The reaction liquid and the ink were applied to the unit area by a single-pass method of performing relative scanning once on the recording head and the recording medium. In the examples and the comparative examples in which “performed” was written in the columns of “drying step”, the recording medium was dried by blowing air for 1 minute using the drying unit 2000 such that the surface temperature of the recording medium reached 60° C. Thereafter, the recording medium was heated for 1 minute using the heating unit 2300 such that the surface temperature of the recording medium reached “temperature T_{H} (° C.) in the heating step” listed in Table 8.
Recording apparatus 2: Cartridges respectively filled with the reaction liquid were set in the ink jet recording apparatus having the configuration shown in FIG. 5. The reaction liquid and the ink were applied to the unit area by a multi-pass method of performing relative scanning a plurality of times on the recording head and the recording medium. In the examples and the comparative examples in which “performed” was written in the columns of “drying step”, the recording medium was dried by blowing air for 1 minute using the drying device provided on the downstream side of the recording head in the conveyance direction of the recording medium such that the surface temperature of the recording medium reached 60° C. Thereafter, the recording medium was heated for 1 minute using the heater 25 such that the surface temperature of the recording medium reached “temperature T_{H} (° C.) in the heating step” listed in Table 8.

### Formation of Holes

The melting of the first resin particle and the generation of holes were confirmed by the following method. The part of the solid image of the recording medium was cut after the heating step at the temperature T_{H} (° C.) listed in Tables 8 and 9, and an observation image of the cross section thereof was captured at a magnification of 100000 using a scanning electron microscope (trade name “S-4700 type scanning electron microscope”, manufactured by Hitachi High-Tech Corporation). The captured image was binarized, and the area ratio of the black parts corresponding to the holes in the entire image was calculated. When the area ratio of the holes in the image was 20% or more, it was determined that holes were generated (listed as “formed” in the columns of “formation of holes” in Table 8). When the area ratio of the holes in the image was less than 20%, it was determined that holes were not generated (listed as “not formed” in the columns of “formation of holes” in Table 8).

### Precipitation Resistance

The prepared ink was poured to a columnar sample container up to a height of 24 mm, and the container was sealed and allowed to stand in an environment of 25° C. for one week. The height of the transparent part of the supernatant was measured after standing, and the precipitation resistance of the ink was evaluated according to the evaluation criteria described below. As the area of the transparent part decreases, this indicates that precipitation of the particle is suppressed, and the precipitation resistance is satisfactory.
A: The height of the transparent part of the supernatant was 7 mm or less.
B: The height of the transparent part of the supernatant was more than 7 mm to 10 mm or less.
C: The height of the transparent part of the supernatant was more than 10 mm.

### Dry Concealing Property

The dry concealing property of the image was evaluated by measuring and calculating the concealing ratio of the recorded image using the method in conformity with ISO 2471:2008. In ISO 2471:2008, a white plate and a black plate were respectively backed onto a recording medium (paper) serving as a test target to measure the reflectivity, and the concealing ratio was calculated from Equation (B).

$$Concealing ratio ( \% ) = ( {R}_{0} / {R}_{∞} ) \times 100 \qquad ( B )$$

R₀ represents the reflectivity measured by backing the black plate.
R_{∞} represents measured by backing the white plate.

In the present example, the concealing ratio of the recorded image was measured and calculated using concealing ratio test paper (white plate and black plate, manufactured by TP Giken Co., Ltd., with inspection certificate from the Japan Paint Inspection and Testing Association) in conformity with the above-described method. Further, the dry concealing property was evaluated according to the following evaluation criteria.
AA: The concealing ratio was 60% or more.
A: The concealing ratio was 55% or more to less than 60%.
B: The concealing ratio was 45% or more to less than 55%.
C: The concealing ratio was less than 45%.

### Water Wet Concealing Property

The recorded image was immersed in water at 25° C. and immediately taken out. Next, water on the surface of the image was wiped off. The concealing ratio of this image was measured and calculated in the same manner as in the evaluation of the above-described dry concealing property. A ratio (%) between the concealing ratios was calculated from a concealing ratio X before the immersion in water (that is, the concealing ratio obtained when the dry concealing property was evaluated) and a concealing ratio Y after the immersion in water based on the equation of “ratio (%) between concealing ratios=[(X−Y)/X]×100”. Further, the water wet concealing property was evaluated according to the following evaluation criteria.
AA: The ratio between the concealing ratios was less than 5%.
A: The ratio between the concealing ratios was 5% or more to less than 10%.
B: The ratio between the concealing ratios was 10% or more to less than 15%.
C: The ratio between the concealing ratios was 15% or more.

TABLE 8
Evaluation conditions and evaluation results

| | | Evaluation conditions | | | | | | | | | |
|---|---|---|---|---|---|---|---|---|---|---|---|
| | | | | | | | Temperature | Evaluation results | | | |
| | | | | | | | T_{H} in | | | Dry | Water wet |
| | | Recording | Recording | Reaction | | Drying | heating | Formation | Precipitation | concealing | concealing |
| | | apparatus | medium | liquid | Ink | step | step (° C.) | of holes | resistance | property | property |
| Example | 1 | 1 | 1 | 1 | 1 | Not performed | 85 | Formed | A | AA | AA |
| | 2 | 1 | 1 | 1 | 2 | Not performed | 85 | Formed | A | AA | AA |
| | 3 | 1 | 1 | 1 | 3 | Not performed | 85 | Formed | A | AA | AA |
| | 4 | 1 | 1 | 1 | 4 | Not performed | 85 | Formed | A | AA | AA |
| | 5 | 1 | 1 | 1 | 5 | Not performed | 85 | Formed | A | AA | AA |
| | 6 | 1 | 1 | 1 | 6 | Not performed | 85 | Formed | A | AA | AA |
| | 7 | 1 | 1 | 1 | 7 | Not performed | 85 | Formed | A | AA | AA |
| | 8 | 1 | 1 | 1 | 8 | Not performed | 85 | Formed | A | AA | AA |
| | 9 | 1 | 1 | 2 | 1 | Not performed | 85 | Formed | A | AA | AA |
| | 10 | 2 | 1 | 1 | 1 | Not performed | 85 | Formed | A | AA | AA |
| | 11 | 1 | 1 | 1 | 9 | Not performed | 85 | Formed | A | A | B |
| | 12 | 1 | 1 | 1 | 10 | Not performed | 85 | Formed | B | B | AA |
| | 13 | 1 | 1 | 1 | 11 | Not performed | 85 | Formed | A | AA | AA |
| | 14 | 1 | 1 | 1 | 12 | Not performed | 85 | Formed | A | AA | B |
| | 15 | 1 | 1 | 1 | 13 | Not performed | 85 | Formed | A | AA | AA |
| | 16 | 1 | 1 | 1 | 14 | Not performed | 85 | Formed | B | B | AA |
| | 17 | 1 | 1 | 1 | 15 | Not performed | 85 | Formed | A | AA | AA |
| | 18 | 1 | 1 | 1 | 16 | Not performed | 85 | Formed | A | B | AA |
| | 19 | 1 | 1 | 1 | 17 | Not performed | 85 | Formed | A | AA | AA |
| | 20 | 1 | 1 | 1 | 18 | Not performed | 85 | Formed | A | AA | AA |
| | 21 | 1 | 1 | 1 | 19 | Not performed | 85 | Formed | A | AA | AA |
| | 22 | 1 | 1 | 1 | 20 | Not performed | 85 | Formed | A | B | AA |
| | 23 | 1 | 1 | 1 | 21 | Not performed | 85 | Formed | A | AA | B |
| | 24 | 1 | 1 | 1 | 22 | Not performed | 85 | Formed | A | AA | AA |
| | 25 | 1 | 1 | 1 | 23 | Not performed | 85 | Formed | A | AA | AA |
| | 26 | 1 | 1 | 1 | 24 | Not performed | 85 | Formed | A | A | AA |
| | 27 | 1 | 1 | 1 | 25 | Not performed | 85 | Formed | A | AA | AA |
| | 28 | 1 | 1 | 1 | 26 | Not performed | 85 | Formed | A | AA | AA |
| | 29 | 1 | 1 | 1 | 27 | Not performed | 85 | Formed | A | AA | AA |
| | 30 | 1 | 1 | 1 | 28 | Not performed | 85 | Formed | A | AA | A |
| | 31 | 1 | 1 | 1 | 29 | Not performed | 85 | Formed | A | A | B |
| | 32 | 1 | 1 | 1 | 30 | Not performed | 85 | Formed | A | AA | A |
| | 33 | 1 | 1 | 1 | 31 | Not performed | 85 | Formed | A | AA | A |
| | 34 | 1 | 1 | 1 | 32 | Not performed | 85 | Formed | A | AA | A |
| | 35 | 1 | 1 | — | 1 | Performed | 85 | Formed | A | A | A |
| | 36 | 1 | 1 | 1 | 1 | Performed | 85 | Formed | A | AA | AA |
| | 37 | 1 | 1 | — | 1 | Not performed | 85 | Formed | A | A | B |
| | 38 | 1 | 1 | — | 33 | Not performed | 85 | Formed | A | B | B |
| | 39 | 1 | 1 | — | 34 | Not performed | 85 | Formed | A | B | B |
| Comparative | 1 | 1 | 1 | 1 | 35 | Not performed | 85 | Formed | A | AA | C |
| Example | 2 | 1 | 1 | 1 | 1 | Not performed | 60 | Not formed | A | C | A |
| | 3 | 1 | 2 | 1 | 36 | Not performed | 300 | Not formed | A | C | AA |
| | 4 | 1 | 1 | 1 | 37 | Not performed | 85 | Formed | C | B | AA |
| | 5 | 1 | 1 | 1 | 38 | Not performed | 85 | Not formed | A | B | C |
| | 6 | 1 | 1 | 1 | 39 | Not performed | 85 | Not formed | A | B | C |
| | 7 | 1 | 1 | 1 | 40 | Not performed | 85 | Not formed | C | A | AA |
| | 8 | 2 | 1 | — | 41 | Performed | 25 | Not formed | A | B | C |
| | 9 | 2 | 1 | — | 42 | Performed | 40 | Not formed | A | C | AA |

The water wet concealing properties of Examples 1, 5 and 8 were all evaluated as AA, but the water-concealing property of Example 1 was relatively excellent when compared to those of Examples 5 and 8.

The present disclosure provides an ink jet recording method that enables recording of an image which has an excellent dry concealing property and suppresses degradation of the water wet concealing property when an aqueous ink having excellent precipitation resistance is used. Further, the present disclosure provides an ink jet recording apparatus used for the ink jet recording method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-203725, filed Nov. 22, 2024 and No. 2025-182973, filed Oct. 29, 2025, which are hereby incorporated by reference herein in their entirety.

What is claimed is:

1. An ink jet recording method of recording an image on a recording medium using an aqueous ink that comprises a particle, a first resin particle and a second resin particle, the method comprising:
applying the aqueous ink to the recording medium; and
heating the recording medium, to which the aqueous ink has been applied, to a temperature higher than or equal to a glass transition temperature Tg_{R1} or a melting point Tm_{R1} of the first rein particle and lower than a glass transition temperature Tg_{P} or a melting point Tm_{P} of the particle,
wherein the particle has an average primary particle diameter D_{P} of 150 nm or less,
a density ratio of a density ρ_{R1} of the first resin particle to a density ρ_{R2} of the second resin particle is more than 1.0 times, and
in the heating of the recording medium, the recording medium is heated to melt the first resin particle so that a hole is generated.

2. The ink jet recording method according to claim 1,
wherein a density ratio of a density ρ_{P} of the particle to a density ρ_{R1} of the first resin particle can be 2.1 times or more.

3. The ink jet recording method according to claim 1,
wherein a total pore volume of the particle, which is measured by a nitrogen adsorption and desorption method, is 0.10 cm³/g or more.

4. The ink jet recording method according to claim 1,
wherein a volume ratio of a content V_{R1} of the first resin particle to a content V_{P} of the particle in the aqueous ink is 1.3 times or more to 5.0 times or less.

5. The ink jet recording method according to claim 1,
wherein a volume ratio of a content V_{R2} of the second resin particle to a content V_{R1} of the first resin particle in the aqueous ink is 0.06 times or more to 0.6 times or less.

6. The ink jet recording method according to claim 1,
wherein the particle comprises a white pigment.

7. The ink jet recording method according to claim 1,
wherein the particle comprises titanium oxide.

8. The ink jet recording method according to claim 1,
wherein a resin forming the first resin particle is at least one selected from the group consisting of an acrylic resin, a polyester-based resin and a urethane-based resin.

9. The ink jet recording method according to claim 1,
wherein the second resin particle is dispersed by a nonionic compound containing at least one hydrophilic group selected from the group consisting of a hydroxy group and an ethylene oxide group.

10. The ink jet recording method according to claim 1,
wherein a resin forming the second resin particle is at least one selected from the group consisting of a wax, rosin ester and an alkyl ketene dimer.

11. The ink jet recording method according to claim 10,
wherein a resin forming the second resin particle is at least one selected from the group consisting of Fischer-Tropsch wax and polyolefin wax.

12. The ink jet recording method according to claim 1,
wherein the aqueous ink is a white ink.

13. The ink jet recording method according to claim 1, further comprising:
at least one selected from the group consisting of (1) applying an aqueous reaction liquid comprising a reactant that reacts with the aqueous ink to the recording medium and (2) drying a liquid component on the recording medium.

14. The ink jet recording method according to claim 13, comprising:
applying an aqueous reaction liquid comprising a reactant that reacts with the aqueous ink to the recording medium.

15. An ink jet recording apparatus which is used for an ink jet recording method of recording an image on a recording medium using an aqueous ink that comprises a particle, a first resin particle and a second resin particle, the apparatus comprising:
an ink applying means that applies the aqueous ink to the recording medium; and
a heating means that heats the recording medium, to which the aqueous ink has been applied, to a temperature higher than or equal to a glass transition temperature Tg_{R1} or a melting point Tm_{R1} of the first rein particle and lower than a glass transition temperature Tg_{P} or a melting point Tm_{P} of the particle,
wherein the particle has an average primary particle diameter D_{P} of 150 nm or less,
a density ratio of a density ρ_{R1} of the first resin particle to a density ρ_{R2} of the second resin particle is more than 1.0 times, and
the recording medium is heated by the heating means to melt the first resin particle so that a hole is generated.
